(19) United States
(12) Patent Application Publication
(10) Pub. No.: US 2015/0370981 A1
(43) Pub. Date: Dec. 24, 2015

(54) SYSTEM AND METHOD FOR PROVIDING RECOMMENDATIONS OF RELEVANT OPPORTUNITIES TO HEALTH PLAN CUSTOMERS

(71) Applicant: CIGNA INTELLECTUAL PROPERTY, INC., WILMINGTON, DE (US)

(72) Inventors: BRANDON NUCKOLLS, GILBERT, AZ (US); SUSAN STRAUSS, WEST HARTFORD, CT (US); JAMES MOTLEY, PORTLAND, OR (US); MICHAEL STURMER, WEST HARTFORD, CT (US); HEATHER DLUGOLENSKI, EAST GRANBY, CT (US); CAMERON OUGH, PORTLAND, OR (US); JOAN BERING KENNEDY, STUART, FL (US)

(73) Assignee: CIGNA INTELLECTUAL PROPERTY, INC., WILMINGTON, DE (US)

(21) Appl. No.: 14/591,222

(22) Filed: Jan. 7, 2015

Related U.S. Application Data
(60) Provisional application No. 62/015,192, filed on Jun. 20, 2014.

(51) Int. Cl. G06F 19/00

(52) U.S. Cl. CPC G06F 19/345; G06F 19/3431

(57) ABSTRACT

In certain implementations, personalized opportunities may be provided to health plan customers. Personal health information associated with a user covered by a health plan may be obtained. Coverage information associated with the health plan may be obtained. A first set recommendations related to opportunities available to the user may be determined based on the personal health information and the coverage information. The first set of recommendations may be provided for presentation to the user. One or more actions of the user with regard to one or more opportunities related to the first set of recommendations may be monitored. A second set of recommendations related to opportunities available to the user may be determined based the personal health information, the coverage information, and the monitoring of the one or more actions of the user. The second set of recommendations may be provided for presentation to the user.

### CROSS-REFERENCE TO RELATED APPLICATION

This application claims priority to U.S. Provisional Patent Application Ser. No. 62/015,192, filed Jun. 20, 2014 (status: pending), which is hereby incorporated by reference herein in its entirety.

### FIELD OF THE INVENTION

The invention relates to proactively providing personalized recommendations of relevant opportunities and/or other recommendations to health plan customers, for example, to help them get the most from their health plan at any given time.

### BACKGROUND OF THE INVENTION

While most health plans generally cover a set of preventive care services, such as screenings, shots, routine exams, or other preventative care services, many health plan customers fail to take advantage of preventative care services that are both cost effective and appropriate for them. Although there is a plethora of health information available to customers—including their personal health information and their health plan benefits, they generally do not have a clear, meaningful way to efficiently access relevant content they can act on. These and other drawbacks exist.

### SUMMARY OF THE INVENTION

The invention addressing these and other drawbacks relates to methods, apparatuses, and/or systems for proactively providing personalized recommendations of relevant opportunities and/or other recommendations to health plan customers.

In certain implementations, different types of user information may be utilized to proactively “mine” for opportunities (or other items) available for users covered by a health plan (hereinafter, “customers,” “covered users,” or “users”), and provide recommendations of opportunities (or other recommendations) to the users. For example, opportunities that are available for users may be determined based on personal health information associated with users (e.g., demographic information, medical diagnoses information, surgical diagnoses information, family diagnoses information, medication information, lab results, etc.), coverage information associated with health plans of users (e.g., benefits covered under the health plans, expiration dates of the health plans, deductibles associated with the health plans, co-payments associated with the health plans, healthcare providers covered under the health plans, etc.), activity information associated with users (e.g., claims submitted by or on behalf of users, purchases of health products or services, actions or inactions of users with regard to recommended opportunities or other recommendations, etc.), preference information (e.g., preferred reference location, preferred appointment times, preferred communication channels, preferred frequency of notifications, preferred opportunity types, preferred reward types, etc.), or other information.

In some implementations, the actions (or inactions) of users with regard to the recommended opportunities (or other recommendations) may be monitored. Information regarding the actions (or inactions) of users may be utilized to generate new opportunities (or modify current opportunities) for users. In another implementation, the information regarding the actions (or inactions) of users may be utilized to generate new recommendations for users. Such recommendations may, for example, be generated to engage healthcare consumers with clear ways to save money, stay healthy, and get the most out of their health plans, thereby improving the healthcare benefits experience of consumers.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 is an exemplary illustration of a system for providing recommendations of relevant opportunities and/or other recommendations to health plan customers, according to an aspect of the invention.

FIG. 2 is another exemplary illustration of a system for providing recommendations of relevant opportunities and/or other recommendations to health plan customers, according to an aspect of the invention.

FIGS. 3-10 are exemplary illustrations of a mobile user interface that provides health plan customers recommendations of relevant opportunities, according to aspects of the invention.

FIGS. 11-12 are exemplary illustrations of a larger-screen user interface that provides health plan customers recommendations of relevant opportunities, according to aspects of the invention.

FIGS. 13-18 are exemplary illustrations of a mobile user interface that enables a user to create and/or modify a team of healthcare providers, according to aspects of the invention.

FIG. 19 is an exemplary illustration of a larger-screen user interface that enables a user to create and/or modify a team of healthcare providers, according to an aspect of the invention.

FIGS. 20-22 are exemplary illustrations of a mobile user interface that enables a user to modify account settings, according to aspects of the invention.

FIG. 23 is an exemplary illustration of a larger-screen user interface that enables a user to modify account settings, according to an aspect of the invention.

FIGS. 24-25 are exemplary illustrations of a mobile user interface that enables a user to access assistance and obtain answers to general health questions, according to aspects of the invention.

FIG. 26 is an exemplary illustration of a larger-screen user interface that enables a user to access assistance and obtain answers to general health questions, according to an aspect of the invention.

FIGS. 27-33 are exemplary illustrations of a mobile user interface that provides an interactive introduction regarding use of a mobile application associated with the mobile user interface, according to aspects of the invention.

FIG. 34 is an exemplary illustration of a flowchart of a method of providing recommendations of relevant opportunities and/or other recommendations to health plan customers, according to an aspect of the invention.

FIG. 35 is an exemplary illustration of a flowchart of a method of generating relevant opportunities for health plan customers, according to an aspect of the invention.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

Exemplary System Description

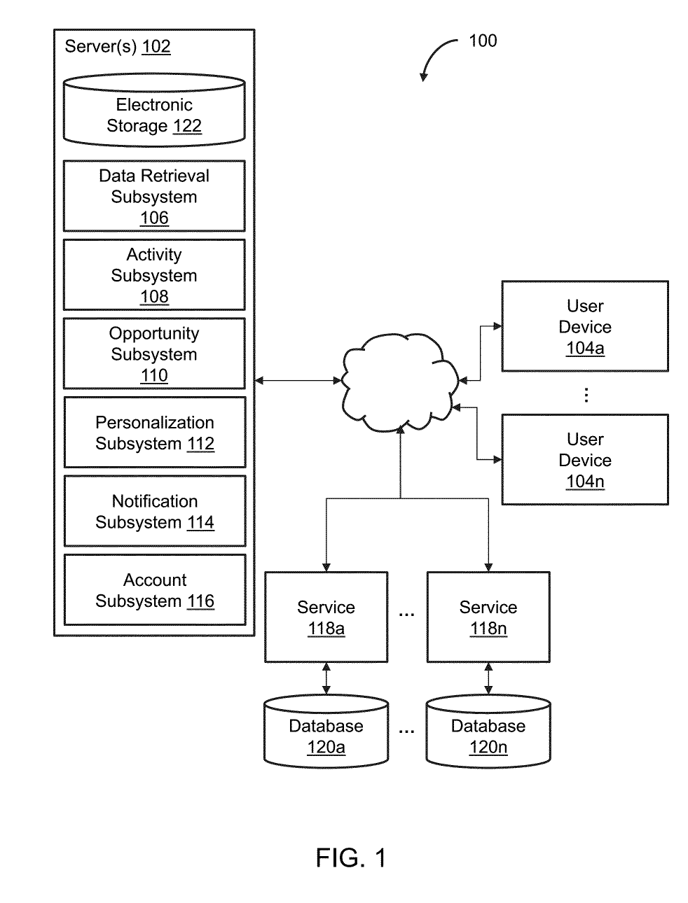

FIG. 1 is an exemplary illustration of a system 100 for providing recommendations of relevant opportunities and/or other recommendations to health plan customers, according to an aspect of the invention. As shown in FIG. 1, system 100 may comprise server 102 (or multiple servers 102). Server 102 may comprise data retrieval subsystem 106, activity subsystem 108, opportunity subsystem 110, personalization subsystem 112, notification subsystem 114, account subsystem 116, or other components.

System 100 may further comprise a user device 104 (or multiple user devices 104a-104n). User device 104 may comprise any type of mobile terminal, fixed terminal, or other device. By way of example, user device 104 may comprise a desktop computer, a notebook computer, a netbook computer, a tablet computer, a smartphone, a navigation device, an electronic book device, a gaming device, or other user device. Users may, for instance, utilize one or more user devices 104 to interact with server 102, one or more services 118a-118n, or other components of system 100. It should be noted that while one or more operations are described herein as being performed by components of server 102, those operations may, in some implementations, be performed by components of user device 104.

In some implementations, the various computers and subsystems illustrated in FIG. 1 may comprise one or more computing devices that are programmed to perform the functions described herein. The computing devices may include one or more electronic storages (e.g., databases 120, electronic storage 122, or other electric storages), one or more physical processors programmed with one or more computer program instructions, and/or other components. The computing devices may include communication lines, or ports to enable the exchange of information with a network or other computing platforms. The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, a digital circuit designed to process information, an analog circuit designed to process information, a state machine, and/or other mechanisms for electronically processing information. In some implementations, the processors may include a plurality of processing units. These processing units may be physically located within the same device, or the processors may represent processing functionality of a plurality of devices operating in coordination. The processors may be programmed to execute computer program instructions to perform functions described herein of subsystems 106, 108, 110, 112, 114, 116, or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 106, 108, 110, 112, 114, or 116 described herein is for illustrative purposes, and is not intended to be limiting, as any of subsystems 106, 108, 110, 112, 114, or 116 may provide more or less functionality than is described. For example, one or more of subsystems 106, 108, 110, 112, 114, or 116 may be eliminated, and some or all of its functionality may be provided by other ones of subsystems 106, 108, 110, 112, 114, or 116. As another example, additional subsystems may be programmed to perform some or all of the functionality attributed herein to one of subsystems 106, 108, 110, 112, 114, or 116.

Attention will now be turned to a more detailed description of various implementations comprising one or more features related to providing recommendations of relevant opportunities and/or other recommendations to health plan customers. It should be noted that features described herein may be implemented separately or in combination with one another.

In certain implementations, personalization subsystem 112 may be programmed to utilize different types of user information to proactively “mine” for opportunities (or other items) available for users, and provide recommendations of opportunities (or other recommendations) to the users. For example, opportunities that are available for users may be determined based on personal health information associated with the users (e.g., demographic information, medical diagnoses information, surgical diagnoses information, family diagnoses information, medication information, lab results, etc.), coverage information associated with health plans of the users (e.g., benefits covered under the health plans, expiration dates of the health plans, deductibles associated with the health plans, co-payments associated with the health plans, healthcare providers covered under the health plans, etc.), activity information associated with the users (e.g., claims submitted by or on behalf of the users, purchases of health products or services, actions or inactions of the users with regard to recommended opportunities or other recommendations, etc.), preference information (e.g., preferred reference location, preferred appointment times, preferred communication channels, preferred frequency of notifications, preferred opportunity types, preferred reward types, etc.), or other information.

In some implementations, activity subsystem 108 may be programmed to monitor the actions (or inactions) of the users with regard to the recommended opportunities (or other recommendations). In one implementation, opportunity subsystem 110 may be programmed to utilize information regarding the actions (or inactions) of the users to generate new opportunities (or modify current opportunities) for the users.

In another implementation, personalization subsystem 112 may be programmed to utilize the information regarding the actions (or inactions) of the users to generate new recommendations for the users. Such recommendations (e.g., recommended opportunities or other recommendations) may, for example, be generated to engage healthcare consumers with clear ways to save money, stay healthy, and get the most out of their health plans, thereby improving the healthcare benefits experience of consumers.

In one implementation, data retrieval subsystem 106 may be programmed to obtain personal health information associated with a user covered under a health plan. Data retrieval subsystem 106 may also be programmed to obtain coverage information associated a health plan (e.g., a health plan under which the user is covered, a health plan available to the user for purchase, etc.). The personal health information may comprise demographic information, medical diagnoses information, surgical diagnoses information, family diagnoses information, medication information, lab results, or other personal health information. The coverage information may comprise benefits covered under the health plan, an expiration date of the health plan, deductibles associated with the health plan, co-payments associated with the health plan, healthcare providers covered under the health plan, or other coverage information.

In one implementation, data retrieval subsystem 106 may be programmed to obtain activity information associated with a user, preference information associated with the user, or other information. The activity information may comprise claim history (e.g., claims submitted by or on behalf of the user), service or product purchase history (e.g., healthcare provider visits, purchases of medication, etc.), actions/inactions history related to recommendations (e.g., whether and/or which recommended opportunities the user acted on), or other activity information. The preference information may comprise preferred reference locations, preferred appointment times, preferred communication channels, preferred frequency of notifications, preferred opportunity types, preferred reward types, or other preference information.

In one implementation, account subsystem 116 may be programmed to manage and/or access account information associated with a user. Account information may comprise identification information, contact information, location information, payment information, status information, personal history information, coverage information, activity information, preference information, or other account information. In some implementations, account subsystem 116 may provide account information to one or more other subsystems to enable the other subsystems to perform their respective operations. As an example, account subsystem 116 may provide an identifier associated with a health plan (under which a user is covered) to data retrieval subsystem 106 to enable data retrieval subsystem 106 to obtain further coverage information of the user (e.g., benefits covered under the health plan, an expiration date of the health plan, deductibles associated with the health plan, co-payments associated with the health plan, healthcare providers covered under the health plan, etc.).

In one implementation, personalization subsystem 112 may be programmed to determine a first set of recommendations related to opportunities available to a user and/or other recommendations for the user. Personalization subsystem 112 and/or notification subsystem 114 may be programmed to provide one or more recommendations of the first set of recommendations to the user (e.g., via a mobile user interface, a larger-screen user interface, email, voice message, text messaging, etc.). Some devices, such as a mobile phone, may utilize a mobile user interface, while other devices, such as desktop, tablet, etc., may utilize a larger-screen user interface. As an example, the first set of recommendations may be determined based on personal health information associated with the user, coverage information associated with a health plan under which the user is covered, activity information associated with the user, preference information associated with the user, or other information.

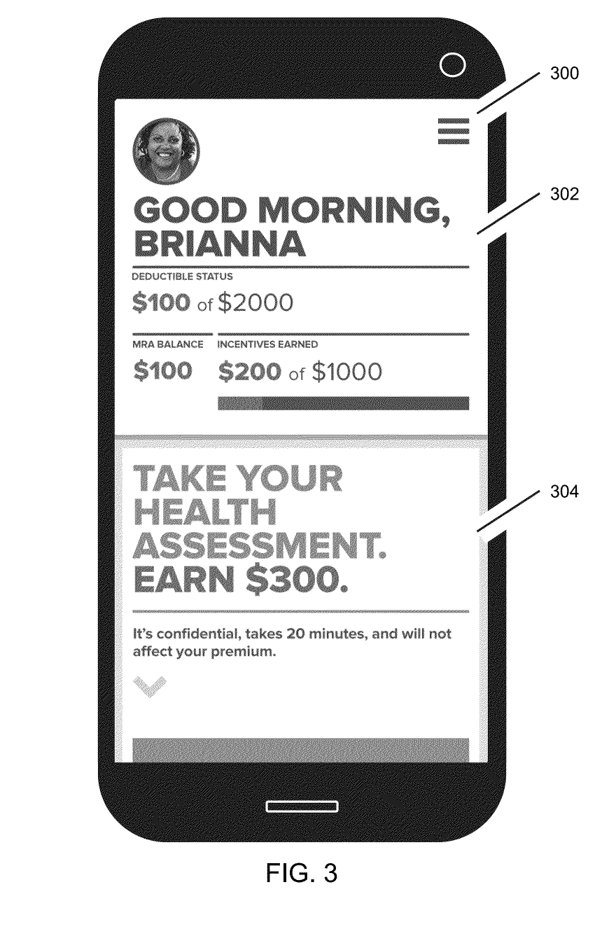

In one use case, with respect to FIG. 3, a user interface 300 may present recommendations, status information, or other information. Section 302 comprises an image of a user covered under a health plan, a welcome message (e.g., “Good Morning, Brianna”), and status information. The status information may comprise a status regarding the portion of a deductible of the health plan that the user has satisfied, a status regarding a balance of a medical reimbursement account (MRA) of the user, a status regarding the portion of potential incentives that the user has earned, or other status information. Such status information may, for example, be pulled by an application associated with user interface 300 or pushed to the application for presentation to the user. In one implementation, status information associated with the user may be stored at one or more databases of server 102 (e.g., a database of electronic storage 122) or associated services 118 (e.g., databases 120). The status information stored at the databases may, for example, be periodically updated based on new transactions, cancelled transactions, or other events that can affect the status information. When the status information is pulled by the application associated with user interface 300, or is pushed to the application, the application may receive the most recent version of the status information that is stored at the databases.

In another implementation, the status information may alternatively or additionally be updated on demand (e.g., upon loading of an application associated with user interface 300, loading of an information card on which the status information is to be presented, an user request for updated status information, etc.). As an example, when one or more non-scheduled conditions are triggered (e.g., loading of the application, loading of the information card, an user request for updated status information, etc.), the application may transmit an update request to server 202 or one or more associated services. In response to the update request, server 202 or the associated services may recalculate one or more portions of the status information based on new transactions, cancelled transactions, or other events that can affect the status information. Upon recalculation, the updated status information may be transmitted to the application. In this way, a user need not wait until the next predefined scheduled update period to obtain updated status information.

In addition, updated status information may be stored at one or more databases so that the status information comprises the most up-to-date version. The updated status information may, for instance, be stored at one or more types of databases. As an example, an updated status regarding the portion of a deductible that a user has satisfied may be stored at an insurance database. An updated status regarding a MRA balance of a user may be stored at a MRA database. A status regarding incentives earned by a user may be stored at a reward database. As such, in some implementations, the application associated with user interface 300 may be programmed to obtain portions of the status information from different sources.

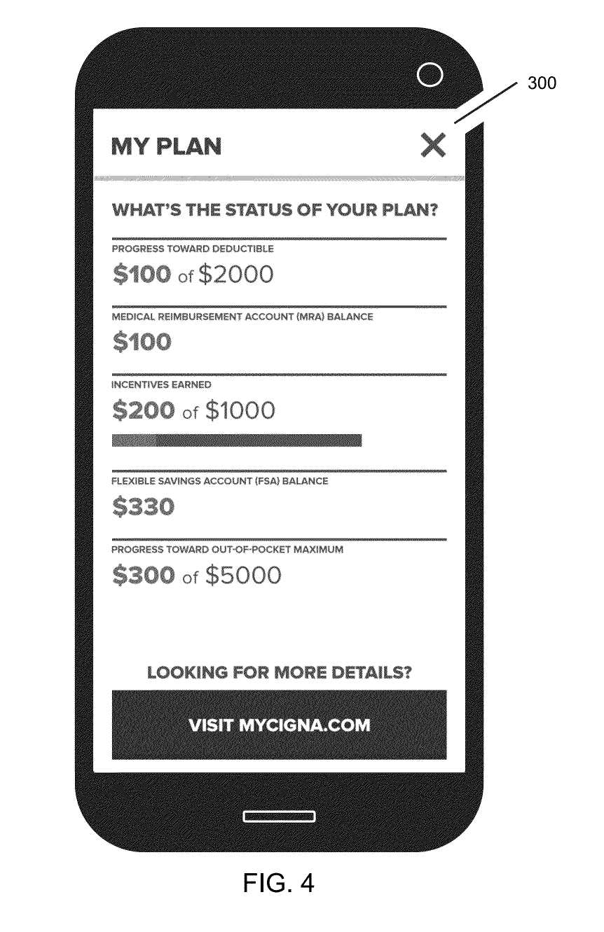

As illustrated in FIG. 4, a user may access additional status information associated with a health plan of the user via user interface 300. As an example, the user may access the additional status information of FIG. 4 by performing a tapping action (or providing another type of input) on information card 304 of FIG. 3.

As shown in FIG. 3, user interface 300 may present relevant information cards (e.g., card 304) to provide recommendations, status information, or other information to the user. Information card 304 comprises, for example, a recommended reward opportunity to earn money for taking a health assessment. In one scenario, the reward opportunity may be recommended to the user as part of an introductory process for new users. In another scenario, the user's personal health information, coverage information, or activity information may be processed to determine recommendations for the user. The reward opportunity depicted in FIG. 3 may, for instance, be recommended to the user based on the user's personal health information (e.g., the reward opportunity is targeted for the user's age group), coverage information (e.g., the benefits under the user's health plan allow the user to earn up to a certain amount of money for completing tasks related to preventive care), activity information, preference information, or other information.

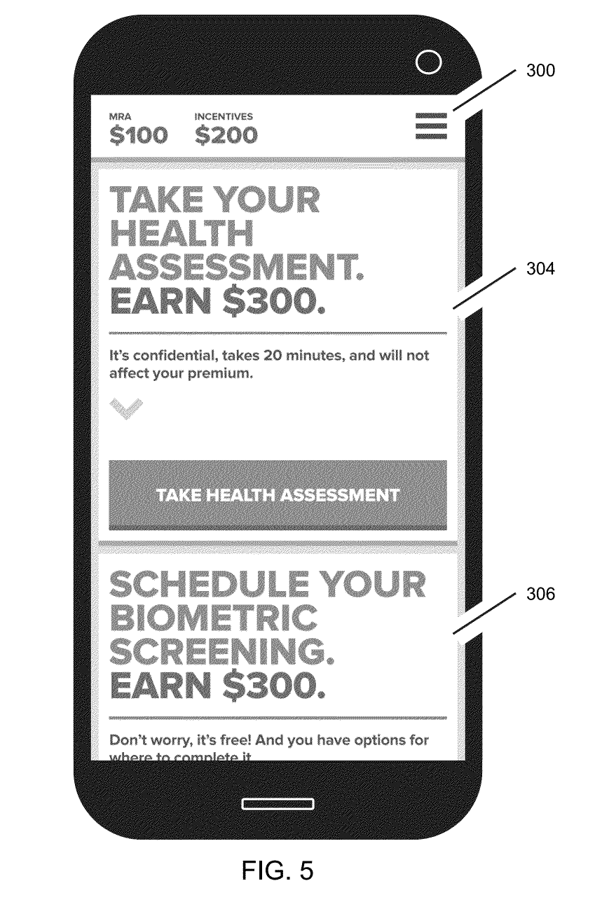

In yet another scenario, with respect to FIG. 5, a second opportunity (e.g., a monetary reward for scheduling a biometric screening, a “free” biometric screening paid for by the user's health plan, etc.) may be presented (on user interface 300) to the user via information card 306. The second opportunity may, for instance, be recommended to the user based on the user's personal health information (e.g., the reward opportunity is targeted for users having a family history with one or more particular health conditions in common with the user's family history), coverage information (e.g., the benefits under the user's health plan provides 100% coverage for the biometric screening, compared to other preventive care services for which the health plan provides less than 100% coverage), activity information, preference information, or other information.

In one implementation, activity subsystem 108 may be programmed to monitor one or more actions of a user with regard to one or more opportunities related to a first set of recommendations for the user. In some implementations, activity subsystem 108 may be programmed to determine whether and/or which recommended opportunities were acted on by the user based on the monitoring of the action of the user.

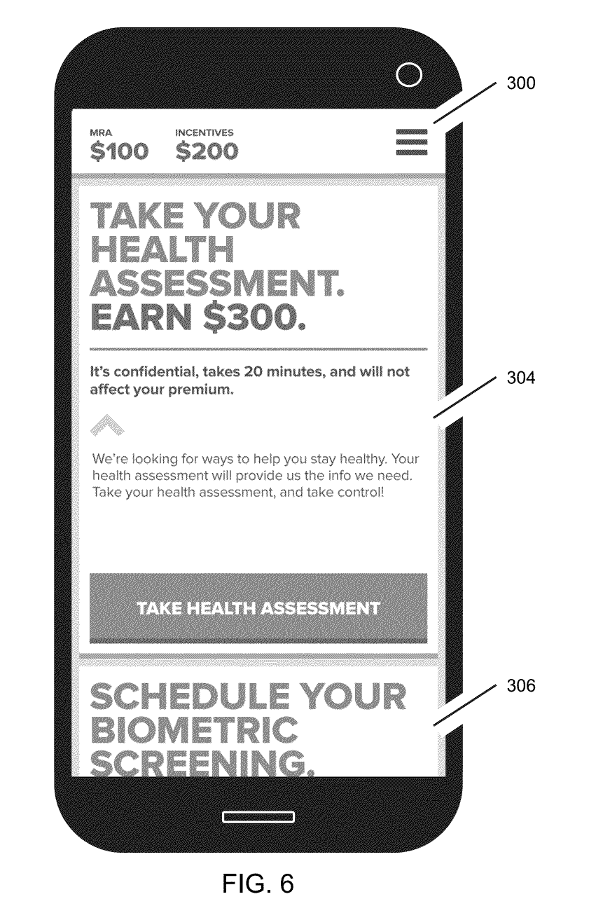

As an example, with respect to FIG. 6, activity subsystem 108 may monitor actions of a user to determine whether the user initiated a health assessment associated with a reward opportunity (e.g., presented in information card 304), whether and/or which questions of the health assessment were answered by the user, whether the user completed the health assessment, etc. Based on the monitoring of the actions of the user, activity subsystem 108 may also determine inactions of the user. Inaction of the user with regard to the reward opportunity may, for instance, be determined based on information indicating that the user has viewed the reward opportunity and the absence of information indicating that the user has acted on the reward opportunity.

In one use case, actions of the user may be determined by activity subsystem 108 in real-time as the user performs the actions. As an example, with respect to FIG. 6, an initiation of the health assessment may be detected via the application, the server, one or more services 118, etc. The application may, for instance, detect the initiation of the health assessment when the user selects the “Take Health Assessment” button. Server 102 may detect the initiation of the health assessment when server 202 processes a link associated with the health assessment (e.g., the link may include a unique code identifying the user). Activity subsystem 108 may, for instance, be integrated with the component that initially detects the initiation of the health assessment (or other action). As such, the component that detects the initiation of the health assessment may forward an indication of the detection to activity subsystem 108. In this way, new opportunities or recommendations may be more quickly determined as a result of the faster feedback regarding the actions or inactions of users, thereby enabling quicker adaption of the recommended opportunities for healthcare customers.

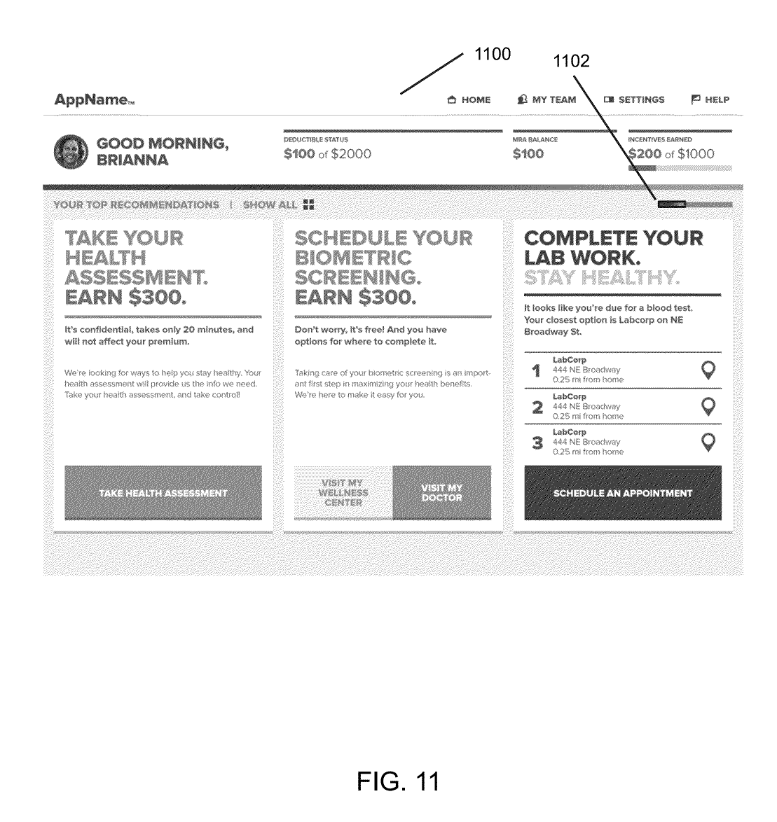

In another use case, information identifying the actions or inactions of users may be stored at one or more databases (e.g., a database of electronic storage 122, databases 120, etc.), and obtained periodically to update a collection of opportunities and/or to recalculate recommendations for users. As an example, with respect to FIG. 11, a reward opportunity associated with scheduling a biometric screening may require that the user has the biometric screening performed at either the user's wellness center or the user's primary care doctor's office in order for the user to earn the monetary reward. If, for instance, the user schedules to have a biometric screening performed by his/her primary care doctor, and the doctor does not have a system that is integrated with activity subsystem 108 (e.g., directly or through another integrated component), information indicating that the user actually had the biometric screen performed may be obtained from a third-party service (that obtains such information from the doctor). As such, due to costs or other considerations, activity subsystem 108 may obtain information identifying the action or inaction of users on a periodic basis.

In one implementation, personalization subsystem 112 may be programmed to determine a second set of recommendations related to opportunities available to a user. Personalization subsystem 112 and/or notification subsystem 114 may be programmed to provide one or more recommendations of the second set of recommendations to the user. As an example, one or more actions of the user (with regard to one or more opportunities of a first set of recommendations) may be monitored to determine whether and/or which recommended opportunities were acted on by the user. The second set of recommendations may be determined based on information identifying whether and/or which recommended opportunities were acted on by the user. The second set of recommendations may also be determined based on personal health information associated with the user, coverage information associated with a health plan under which the user is covered, additional activity information, preference information, or other information.

In one implementation, personalization subsystem 112 may be programmed to determine one or more opportunities available to a user that are similar to recommended opportunities taken by the user. In some implementations, personalization subsystem 112 may be programmed to determine a second set of recommendations of opportunities based on one or more opportunities that are similar to a previously recommended opportunity (of a first set of recommendations) taken by the user. As an example, one or more recommendations of the second set of recommendations may be selected from: (i) similar opportunities that have not yet been recommended to the user; (ii) similar opportunities that have not been recommended to the user for at least a predetermined threshold period of time; or (iii) or other opportunities.

In one implementation, personalization subsystem 112 may be programmed to determine whether opportunities are similar to one another. As an example, each opportunity may be associated with one or more attributes, and the attribute values of one opportunity may be compared to corresponding attribute values of another opportunity to determine their similarity value. Attributes of an opportunity may comprise an amount of reward, a type of the reward (e.g., real world money, virtual currency, points, products, services, etc.), tasks that are to be performed to obtain a reward (e.g., type of tasks, number of tasks, location of tasks, etc.), ratings associated with the opportunity (e.g., user-provided ratings), or other attributes.

In one use case, if a first opportunity is recommended to a user, and the first opportunity is taken by the user, attribute values of the first opportunity may be compared with corresponding values of other opportunities to determine at least a second opportunity to be recommended to the user. As an example, personalization subsystem 112 may compare the first opportunity to a set of other opportunities, and calculate a similarity value for each of the other opportunities. The similarity values may, for instance, indicate the level of similarity between the other opportunities and the first opportunity. Personalization subsystem 112 may then provide at most a predetermined threshold number of the other opportunities as recommendations to the user based on the similarity values of the other opportunities (e.g., the 10 opportunities with the highest 10 similarity values are recommended to the user). As another example, personalization subsystem 112 may provide another opportunity as a recommendation to the user based on the similarity value of the other opportunity satisfying a threshold value for recommendation to the user. As yet another example, the other opportunity may be recommended to the user if its similarity value is at least 80/100. As a further example, the other opportunity may be recommended to the user during a time period if its similarity value is at least 70/100 and if no more than 10 opportunities have been recommended to the user during the same time period. Other ranking scales or metrics may, of course, be implemented.

In one implementation, personalization subsystem 112 may be programmed to determine a similarity value of a second opportunity with respect to a first opportunity based on one or more differences between corresponding attribute values. In some implementations, personalization subsystem 112 may be programmed to determine the similar value of the second opportunity based on the differences and attribute weights of the attributes. As an example, Table 1 (below) illustrates exemplary attributes, values, and weights of Opportunities X and Y.

TABLE 1

| Opp. X and Y | Opportunity X | Opportunity Y | |
|---|---|---|---|
| Attributes | Attribute Values | Attribute Values | Attribute Weight |
| A-Category Level 1 | [STRING 1] | [STRING 1] | [NUMBER A1] |
| A2-Category Level 2 | [STRING 2] | [STRING 3] | [NUMBER A2] |
| B | [NUMBER 1] | [NUMBER 3] | [NUMBER B] |
| C | [NUMBER 2] | [NUMBER 4] | [NUMBER C] |

### Table 1

In one implementation, personalization subsystem 112 may be programmed to determine recommendations of opportunities for a user based on recommended opportunities taken by one or more other users that are similar to the user. As an example, each user may be associated with one or more attributes, and the attribute values of one user may be compared to corresponding attribute values of another user to determine their similarity value. Attributes of a user may comprise personal-health-related attributes (e.g., age, age group, race, ethnicity, disease or other medical conditions of the user, disease or other medical conditions of the user's family, medications being taken by the user, etc.), health-plan-coverage-related attributes (e.g., type of health plan, benefits, deductibles, co-payments, etc.), activity-related attributes (e.g., types of opportunities taken by the user, types of opportunities viewed but ignored by the user, etc.), preference-related attributes, or other attributes.

In one use case, the assessment of whether an opportunity is to be recommended to a user may be based on the number of similar users that have taken the opportunity (or a similar opportunity), the similarity between the user and those similar users (e.g., the similarity values of the similar users with respect to the user), the similarity between the similar opportunity and the opportunity being assessed, or other parameters. As an example, if a relatively high number of similar users have taken the opportunity, and the similarity between the user and those similar users is relatively low, the opportunity may not be recommended to the user. As another example, if a relatively high number of similar users have taken the opportunity, and the similarity between the user and those similar users is relatively high, the opportunity may be recommended to the user.

In one implementation, opportunity subsystem 110 may be programmed to generate a set of opportunities available to one or more users. The set of opportunities may, for example, be generated based on personal health information, coverage information, activity information, preference information, or other information associated with one or more users for which the set of opportunities are available.

In some implementations, activity subsystem 108 may be programmed to monitor actions of users with regard to opportunities recommended for the users. Opportunity subsystem 110 may be programmed to generate a set of opportunities based on the monitoring of the actions of the users. As an example, actions of the users may, for example, be monitored to determine whether and/or which of the recommended opportunities were acted on by the users, such as whether a user initiated steps toward obtaining a recommended opportunity after being presented with the recommended opportunity, whether a user completed some or all of the tasks necessary to obtain the recommended opportunity, etc. The set of opportunities may be generated (e.g., for the users, other users, etc.) based on information identifying whether and/or which of the recommended opportunities were acted on by the users.

In one implementation, opportunity subsystem 110 may be programmed to generate a first set of opportunities that are available to a first set of users, a second set of opportunities that are available to a second set of users, or other set of opportunities. In some implementations, activity subsystem 108 may be programmed to monitor actions of the first set of users with regard to the first set of opportunities. The actions of the first set of users may, for example, be monitored to determine whether and/or which of the first set of opportunities were acted on by the first set of users. Opportunity subsystem 110 may be programmed to generate the second set of opportunities (that are available to the second set of users) based on information identifying whether and/or which of the first set of opportunities were acted on by the first set of users. As such, the actions of the first set of users with regard to the first set of opportunities may affect a subsequent second set of opportunities that are generated to be available to the second set of users.

In one implementation, activity subsystem 108 may be programmed to monitor the actions of the second set of users with regard to the second set of opportunities, for example, to determine whether and/or which of the second set of opportunities were acted on by the second set of users. Opportunity subsystem 110 may be programmed to generate a third set of opportunities that are available to the first set of users or a third set of users based on information identifying whether and/or which of the second set of opportunities were acted on by the second set of users. Thus, the actions of the second set of users with regard to the second set of opportunities may affect a further set of opportunities available to the first set of users (whose previous actions affected the opportunities available to the second set of users) or a further set of opportunities available to the third set of users.

In one implementation, opportunity subsystem 110 may be programmed to manage rewards associated with opportunities based on the action (or inaction) of users with regard to healthcare opportunities (or other opportunities). As an example, rewards associated with a set of opportunities may be reduced (e.g., relative to rewards of opportunities similar to the set of opportunities) based on the demand for the similar opportunities being higher than predefined goals for the similar opportunities. As another example, rewards associated with a set of opportunities may be increased (e.g., relative to rewards of opportunities similar to the set of opportunities) based on the demand for the similar opportunities being less than predefined goals for the similar opportunities. These changes to the rewards may, for example, be performed automatically based on a set of predefined rules (e.g., without a user request to initiate the changes).

In one use case, a health plan may provide 100% coverage for a routine annual health exam that is performed by an in-network doctor (e.g., even before a deductible associated with the health plan is satisfied). As such, opportunity subsystem 110 may make available, to a first set of users during a first time period, a first opportunity that provides a “free” routine annual health exam (when performed by an in-network doctor) and a $200 dollar bonus reward upon completion of the exam. If, for example, about 50% of the first set of users that viewed the first opportunity take advantage of the first opportunity, and that 50% value is greater than a predefined goal for the first opportunity, opportunity subsystem 110 may generate a second opportunity that provides the “free” routine annual health exam and a $100 dollar bonus reward upon completion of the exam, and make the second opportunity available to a second set of users during a second time period. Other dollar amounts and/or goal values may, of course, be implemented.

In one implementation, opportunity subsystem 110 may be programmed to determine users for a second set of users that are to be eligible (or to be recommended) for a second opportunity based on the similarity of the users of the second set to users of a first set of users (to which a first opportunity similar to the second opportunity was made available). As an example, opportunity subsystem 110 may determine a second set of users such that the makeup of the second set of user is similar to the makeup of the first set of users. With respect to the first set of users, for instance, the second set of users may comprise similar percentages of users in respective age groups, similar percentages of users having respective medical conditions in their family histories, similar percentage of users having respective health plans, etc. In this way, the results of providing similar opportunities (or recommendations thereof) to different sets of users may be more accurately predicted. In addition, the reasons for differences among results associated with the opportunities (e.g., the percentage of users that act on a respective opportunity made available to the users) may be reduced. As such, the results associated with the opportunities (or recommendations thereof) may be more efficiently analyzed.

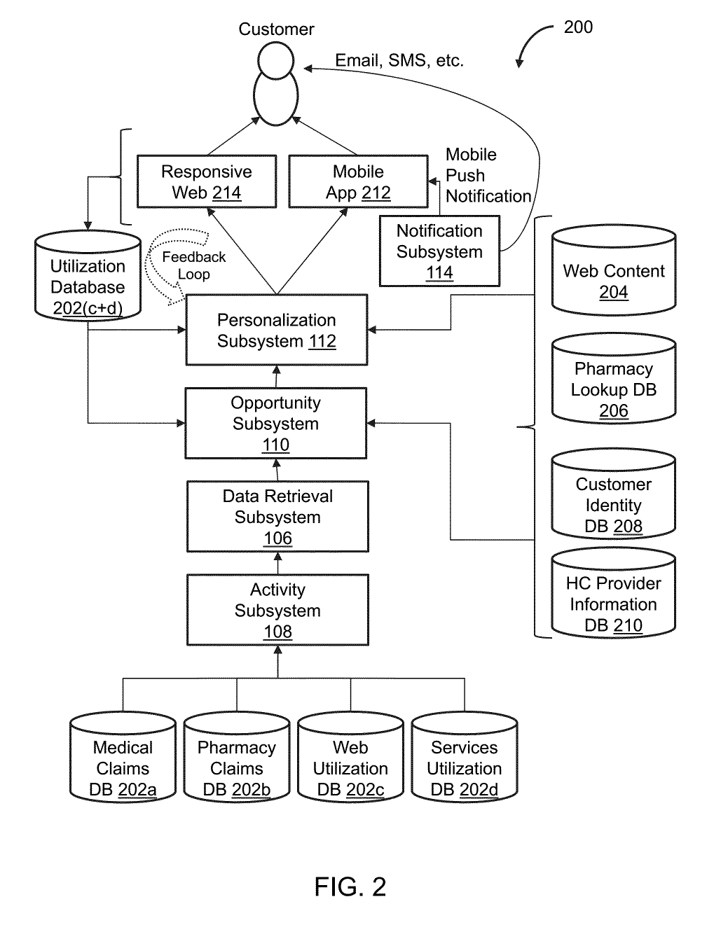

In one implementation, as shown in FIG. 2, another exemplary system 200 may provide recommendations of relevant opportunities and/or other recommendations to health plan customers. In some implementations, rules may be utilized to facilitate opportunities and/or recommendations. As discussed, opportunities may be available to a customer and/or recommended to the customer based on personal health information associated with the customer, coverage information associated with a health plan under which the customer is covered, activity information associated with the customer, preference information associated with the customer, or other information. Such information associated with the customer may, for example, be processed along with one or more rules to determine whether one or more conditions associated with an opportunity and/or recommendation are satisfied to make the opportunity available to the customer and/or provide the recommendation to the customer. In one use case, a rule associated with an opportunity (e.g., a reward opportunity associated with a biometric screening) may require that, before the opportunity is made available or recommended to a customer: (i) the customer has a healthcare plan that allows the customer to have a biometric screening performed for the customer with at most a 10% co-pay for the biometric screening; and (ii) the customer has not had a biometric screening performed for the customer within the last year. If these two conditions of the rule are satisfied, then the opportunity may be made available and/or recommended to the customer.

In another use case, a rule associated with a recommendation (e.g., a recommendation that a customer should have a primary care physician along with information identifying the benefits of having a primary care physician) may require that, before the recommendation is provided to a customer: (i) the customer visited a healthcare provider more than twice in the last year; and (ii) the customer does not have a primary care physician. If these two conditions of the rule are satisfied, then the recommendation may be provided to the customer.

In some implementations, activity subsystem 108 may be programmed to monitor for customer activity data updates from one or more databases, such as medical claims database 202a, pharmacy claims database 202b, web utilization database 202c, services utilization database 202d, or other databases. Upon detecting an update, activity subsystem 106 may work with data retrieval subsystem 106 to obtain the updated activity information (e.g., actions or inactions of customers with respect to opportunities and/or recommendations, medical claims submitted by or on behalf of customers, pharmacy claims submitted by or on behalf of customers, etc.). The updated activity information may be utilized by opportunity subsystem 110 and/or personalization subsystem 112 to provide opportunities and/or recommendations.

In some implementations, medical claims database 202a may store information regarding customers that visited healthcare providers, the healthcare providers visited by the customers, dates/times/location of the customer visits to the healthcare providers, services rendered by each of the healthcare providers during each of the customer visits, cost to the customers for the rendered services, cost to health plan providers for the rendered services, or other information.

Pharmacy claims database 202b may store information regarding pharmacy prescriptions or purchases, healthcare providers that wrote the prescriptions or facilitate the purchases, dates/times/locations at which the pharmacy prescriptions were written, dates/times/locations of the pharmacy purchases, cost to the customers for the pharmacy prescriptions/purchases, cost to health plan providers for the pharmacy prescriptions/purchases, or other information.

Web utilization database 202c may store information regarding activities of customers on web assets (e.g., a company's website or mobile application, a third party website or mobile application, etc.). The stored activity information may, for example, indicate login periods, browsers (or other applications) being used to access information on the web assets, devices being used to access information on the web assets, language, locale, or other preferences, timing of web/pages views, or other activity information.

Services utilization database 202d may store information regarding customers' historical usage of company services (e.g., a health plan provider's services or other services offered by other types of companies). The stored information regarding customers' historical usage of company services may, for example, indicate interactions with a clinical subject matter expert (e.g., a coaching program, an employee assistance program, etc.), client-sponsored incentive services in which the customers have not participated, or other information.

In some implementations, activity subsystem 108 may be programmed to monitor for customer activity data updates from other databases. As an example, activity subsystem 108 may monitor for customer activity data updates from a database that stores information regarding purchases of customers that are unrelated to medical/pharmacy claims, trips taken by customers, movies or television shows watched by customers, or other information. Such information (unrelated to medical/pharmacy claims) may, for example, be utilized by opportunity subsystem 110 and/or personalization to create and/or recommend opportunities with incentives tailored to the interests of customers (e.g., if a particular customer likes a specific product, then an opportunity with the specific product as an incentive may be recommended to the customer).

In some implementations, with respect to FIG. 2, opportunity subsystem 110 and/or personalization subsystem 112 may be programmed to obtain web content, pharmacy/medication information, customer identity information, healthcare provider information, or other information from one or more sources (e.g., web content 204, pharmacy lookup 206, customer identity database 208, healthcare provider database 210, etc.). Opportunity subsystem 110 and/or personalization subsystem 112 may then provide opportunities, recommendations, or other information to customers based on the obtained information. In some implementations, with respect to FIG. 2, notification subsystem 114 may be programmed to provide notifications regarding opportunities, recommendations, or other information to customers (e.g., via mobile push notifications to mobile app 212, via email, via text messaging, etc.).

As shown in FIG. 2, customers may interact with other components of the system 200 via a mobile application 212 (e.g., via a smartphone, via a tablet, etc.), responsive web 214 (e.g., via a desktop, laptop, etc.), or other user applications. Utilization (e.g., action or inaction of the users/customers with regard to opportunities and/or recommendations) may, for example, be detected from the customers' use of the mobile application 212 or responsive web 214. In some implementations, at least some utilization information may be fed to opportunity subsystem 110 and/or personalization subsystem 112 (e.g., in real-time) to enable opportunity subsystem 110 and/or personalization subsystem 112 to generate opportunities and/or recommendations based on the utilization information. In some implementations, at least some of the utilization information (e.g., performance of a service by a healthcare provider) may be obtained by one or more third-party entities, and thereafter stored in web utilization database 202c or services utilization database 202d. Utilization information that has not been provided to opportunity subsystem 110 and/or personalization subsystem 112 may be detected as updates by activity subsystem 108. As such, data retrieval subsystem 106 may obtain the utilization information from the respective database 202 for opportunity subsystem 110 and/or personalization subsystem 112.

In one implementation, personalization subsystem 112 may be programmed to provide a user interface on which recommendations (or other information) are presented to a user. The user interface may, for example facilitate the presentation of the recommendations (or other information) to improve the healthcare benefit experience of healthcare customers.

In one scenario, as illustrated in FIG. 5, additional information cards comprising recommended opportunities or other information may be accessed by scrolling down on user interface 300 (e.g., by performing a swipe action). The scrolling may, for example, cause section 302 to become hidden to make more efficient use of the available screen area.

As shown in FIG. 6, user interface 300 may enable the user to expand the visible area of information cards (e.g., card 304) to enable additional information to be simultaneously presented in information card. As an example, information card 304 may have been expanded when the user performed a tapping (or other) action on information card 304. Upon detection of the tapping action, the application may map the tapping action to an expansion call that causes the visible area of information card 304 to be expanded and the additional information to be presented in information card 304.

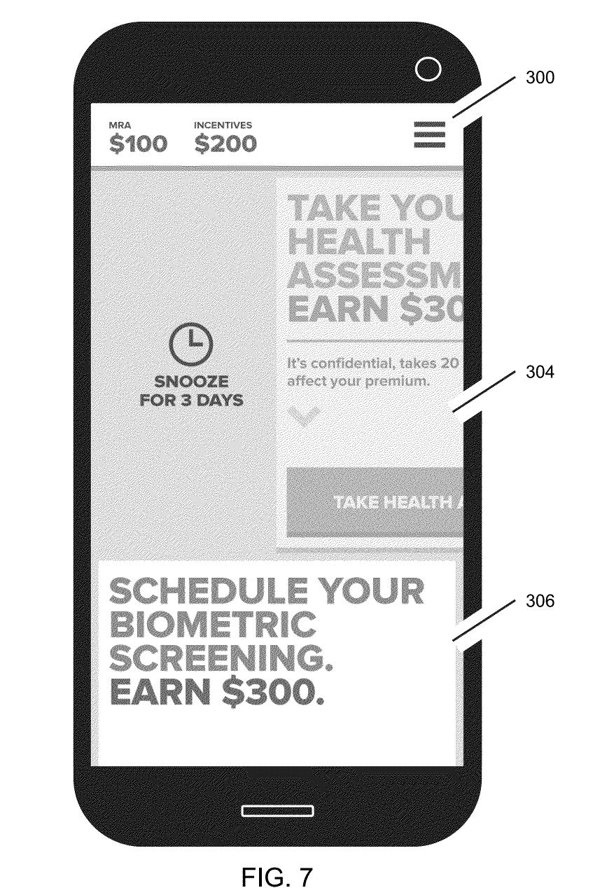

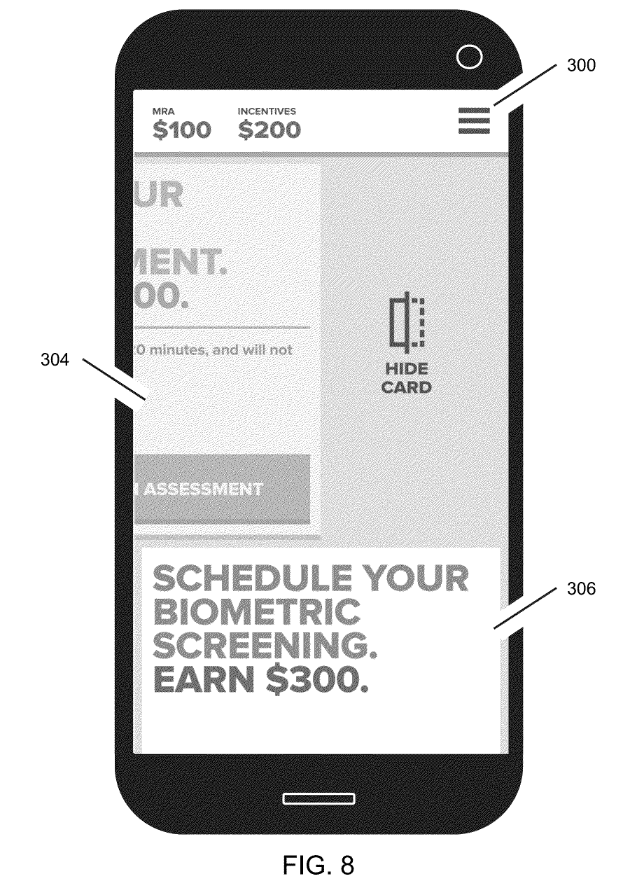

As depicted in FIGS. 7 and 8, user interface 300 may enable a user to perform actions on the information cards or the associated opportunities. As an example, with respect to FIG. 7, user interface 300 enables the user to hide an information card (e.g., card 304) and add a reminder for the user regarding the opportunity associated with the information card with a single action (e.g., a right swipe gesture to “snooze” an opportunity for a predetermined time period). As another example, with respect to FIG. 8, user interface 300 enables the user to hide an information card without adding a reminder for the user regarding the associated opportunity (e.g., a left swipe gesture to hide an opportunity).

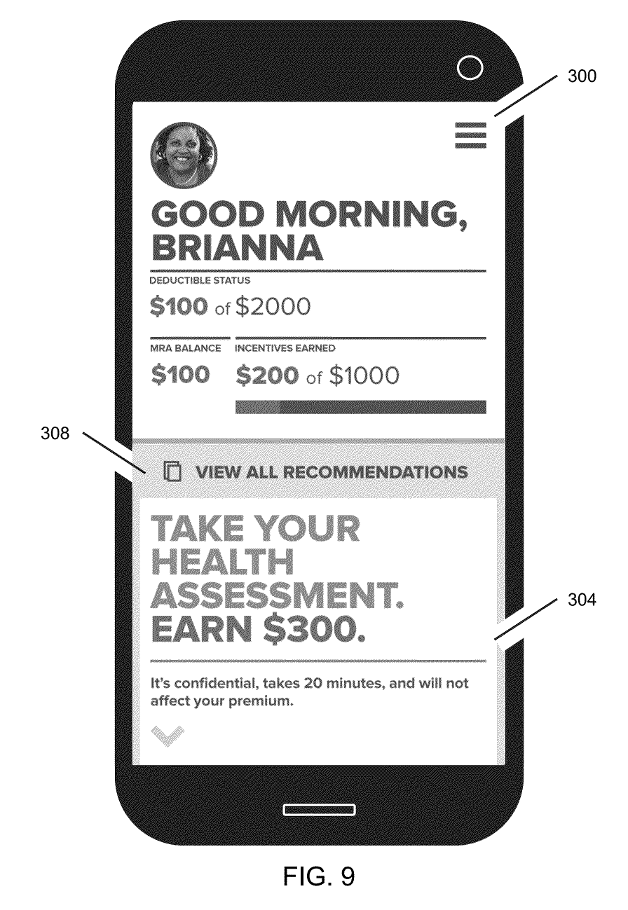

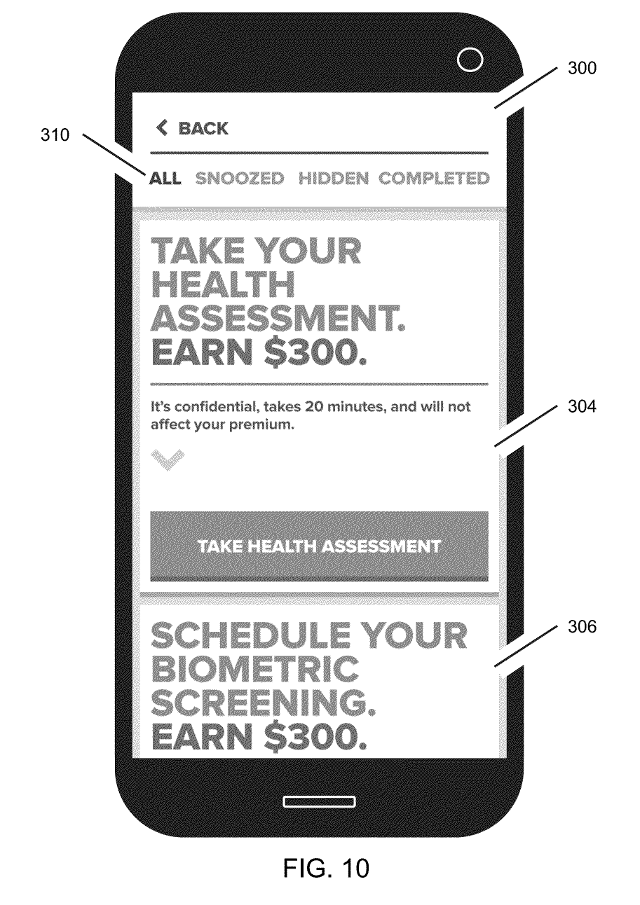

As shown in FIGS. 9 and 10, user interface 300 may enable a user to filter the information cards that are currently presented. As an example, with respect to FIG. 9, user interface 300 may present one or more filter options (e.g., “View All Recommendations” option 308) when the user drags or swipes down on the first listed information card (e.g., card 304). In response to the user's selection of a filter option (e.g., “View All Recommendations”), user interface 300 may present information cards to the user based on parameters of the selected filter option. In addition, user interface 300 may present one or more other filter options (e.g., options 310) to the user to facilitate alternative/further filtering of information cards.

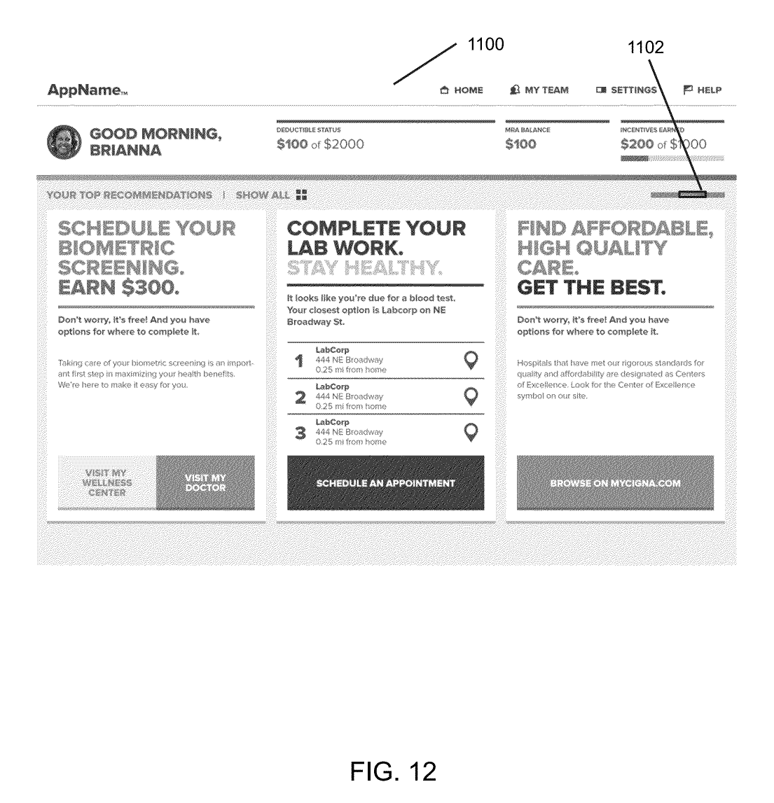

As an example, as shown FIGS. 11 and 12, user interface 1100 provides a visual indicator 1102 on a bar to indicate the user's horizontal position relative to the set of recommendations presented (or to be presented) on user interface 1100 (e.g., the row of top ranked recommendations that are currently loaded on user interface 1100, the row of top ranked recommendations comprising both recommendations that are currently loaded and not yet loaded on user interface 1100, etc.) As another example, user interface 1100 may provide a visual indicator (e.g., on a bar or other representation) to indicate the user's vertical position relative to the set of recommendations on user interface 1100.

It should be noted that, although some implementations are described herein with respect to providing recommendation of opportunities, one or more features of those implementations may be utilized in other implementations to provide other recommendations (e.g., recommendations of health care providers, recommendations of medications, recommendation of workouts, recommendation of additional or alternative health plan coverage, or other recommendations).

In one implementation, personalization subsystem 112 may be programmed to determine one or more recommendations of healthcare providers for a user based on personal health information associated with the user, coverage information associated with a health plan under which the user is covered, activity information associated with the user, preference information, or other information. Personalization subsystem 112 and/or notification subsystem 114 may be programmed to provide the recommendations of the healthcare providers to the user.

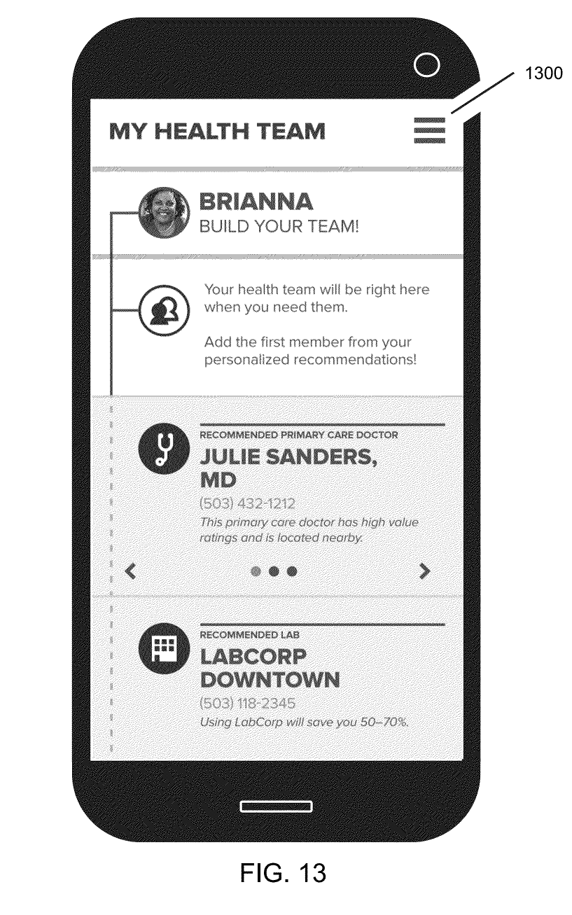

As an example, with respect to FIG. 13, a primary care doctor (e.g., Julie Sanders, MD) may be recommended to a user based on the ratings of the primary care doctor (e.g., ratings provided by colleagues, ratings provided by patients, ratings provided by patients similar to the user, etc.), the location of the primary care doctor's office relative to the user's preferred reference location (e.g., the user's residential location), the available appointment times of the primary care doctor (e.g., whether those appointment times satisfy preferred appointment times of the user), the costs of services of the primary care doctor to the user (e.g., the portion of the costs to be paid by the user after the covered portion of the costs are paid by the health plan provider), the cost of services of the primary care doctor to the health plan provider (e.g., the portion of the costs to be paid by the health plan provider), or other information.

As another example, with respect to FIG. 13, a lab (e.g., LabCorp Downtown) may be recommended to the user based on the ratings of the lab, the location of the lab relative to the user's preferred reference location, the available appointment times of the lab, the cost of services of the lab to the user (e.g., “Using LabCorp will save you 50-70%”), the cost of services of the lab to the health plan provider, or other information.

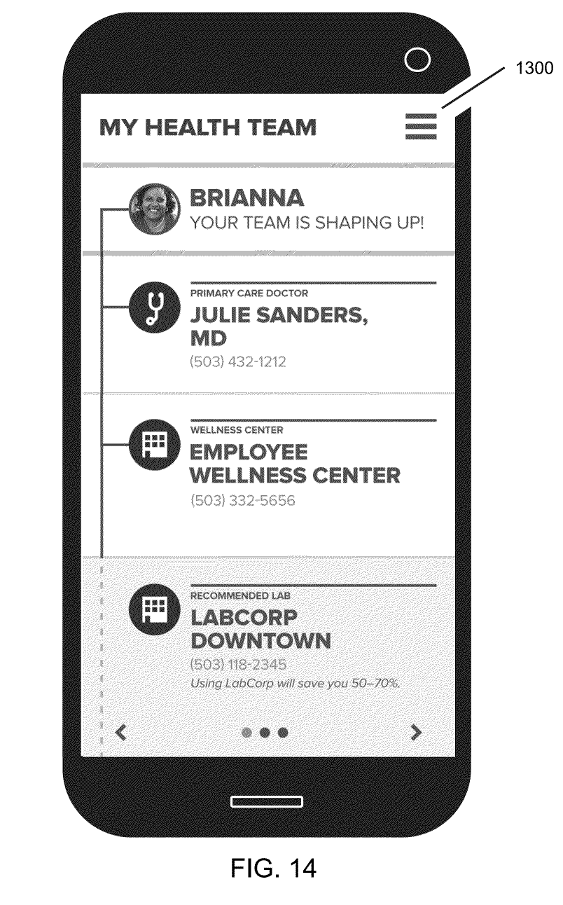

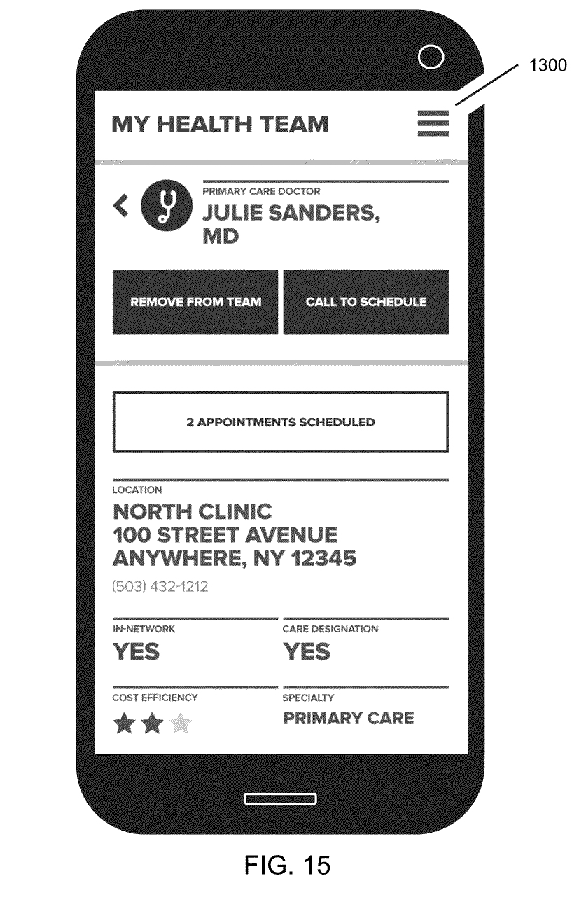

In one scenario, as shown in FIGS. 13 and 14, the recommended healthcare providers may be presented to the user via user interface 1300 to enable the user to add healthcare providers to the user's “health team.” As illustrated in FIG. 15, user interface 1300 may also enable the user to access information regarding a healthcare provider (e.g., location information, contact information, in-network/out-of-network status, additional special status of the healthcare provider assigned by the health plan provider or other entity, costs of services relative to other similar healthcare providers, a specialty of the healthcare provider, available appointment times, etc.), view scheduled appointments of the user with the healthcare provider, schedule an appointment with the healthcare provider, or perform other functions.

In another scenario, user interface 1300 may enable a user to schedule an appointment with a healthcare provider (or other entity). As an example, user interface 1300 may present one or more available appointment times of a healthcare provider along with one or more scheduling mechanisms (e.g., a “Schedule for next Monday at 1 PM” button) to schedule an appointment at an available appointment time. The available appointment times and the scheduling mechanisms may be presented, for example, as part of presenting a recommended opportunity to the user (e.g., as part of an information card comprising the recommended opportunity), upon a selection of the healthcare provider by the user, a search for healthcare providers (e.g., where the search results comprise the healthcare provider), etc. In some scenarios, the available appointment times may be selected based on the user's preference information (e.g., preferred appointment times) to reduce the number of appointment times that are presented at a given time to the user.

In a further scenario, a scheduling mechanism may enable the user to schedule an appointment with the healthcare provider at an appointment time associated with the scheduling mechanism (e.g., a “Schedule Annual Routine Exam for next Tuesday at 7 AM” button). Upon activation of the scheduling mechanism by the user (and without further input from the user) personalization subsystem 112 and/or account subsystem 116 (or other subsystem) may obtain information associated with the user, and schedule the appointment with the healthcare provider at the associated appointment time. Personalization subsystem 112 may, for example, schedule the appointment with the healthcare provider by placing the appointment on a calendar associated with the healthcare provider, sending a request to the healthcare provider to confirm the appointment, etc.

As an example, user interface 1300 may present appointment times with corresponding “Instantly Schedule Now” buttons alongside the appointment times (e.g., “Tuesday, July 15 at 7 AM” with an “Instantly Schedule Now” button). When the user activates the button (e.g., by clicking, tapping, long pressing, etc. the button), and without further input from the user, personalization subsystem and/or account subsystem 116 may obtain the user's identification information (e.g., name, social security, etc.), contact information, location information, personal history information, coverage information, preference information, payment information, or other information, and provide the obtained information to the healthcare provider in conjunction with scheduling the appointment with the healthcare provider. In this way, aspects of the invention may improve the appointment scheduling experience of users, and enable healthcare providers to obtain necessary information of the user without having to manually obtain the information from the user.

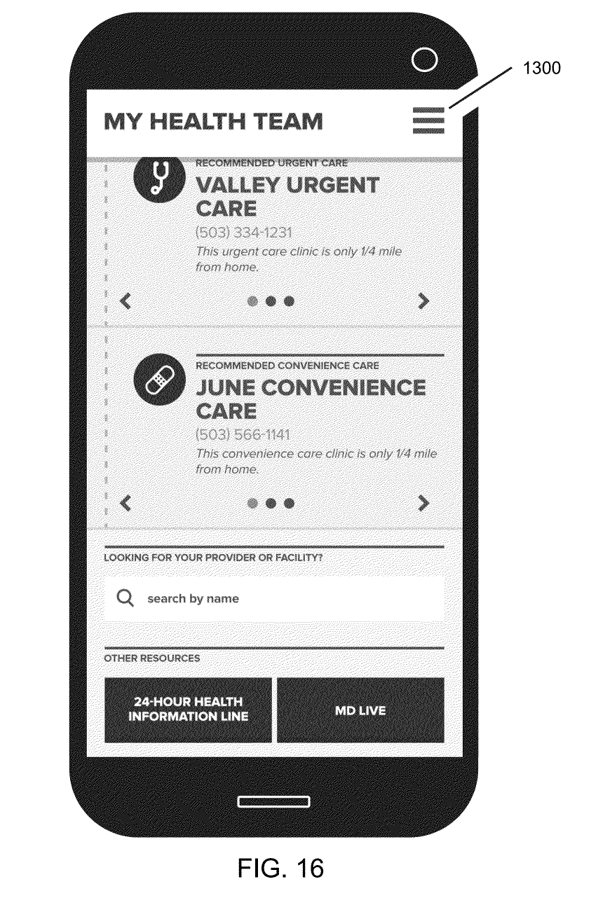

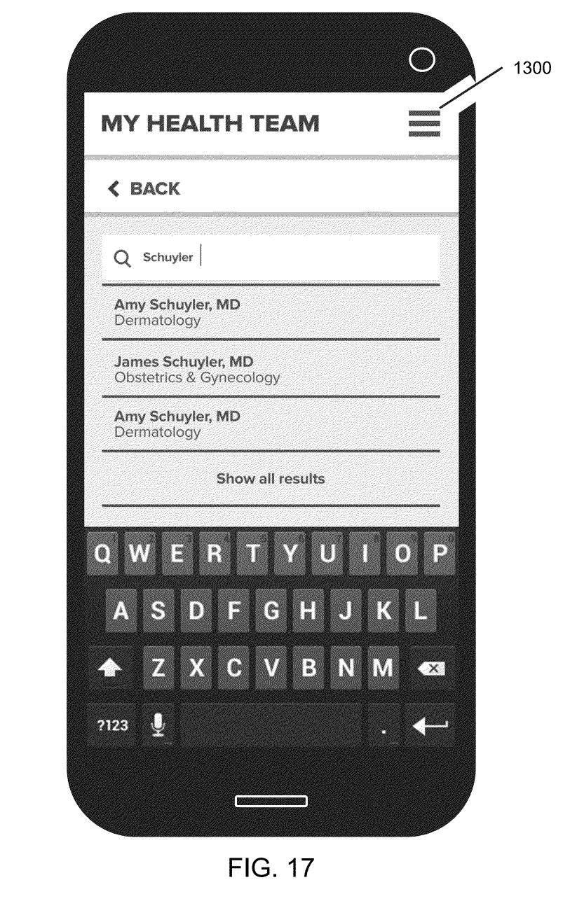

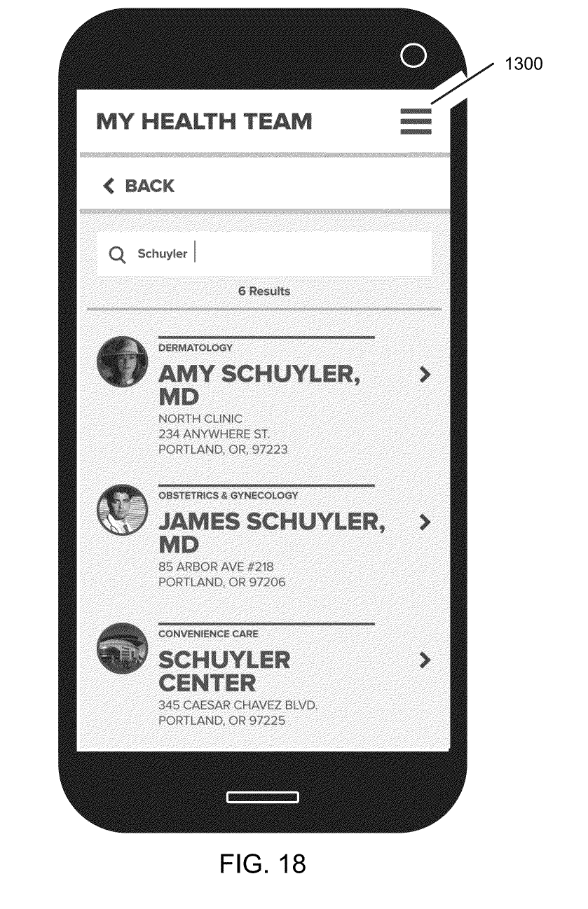

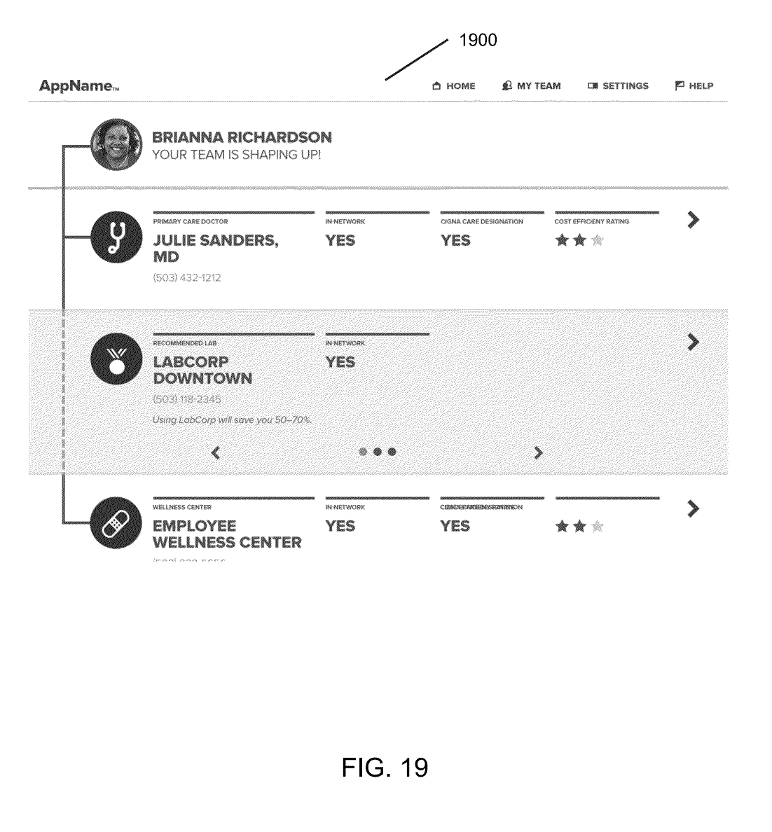

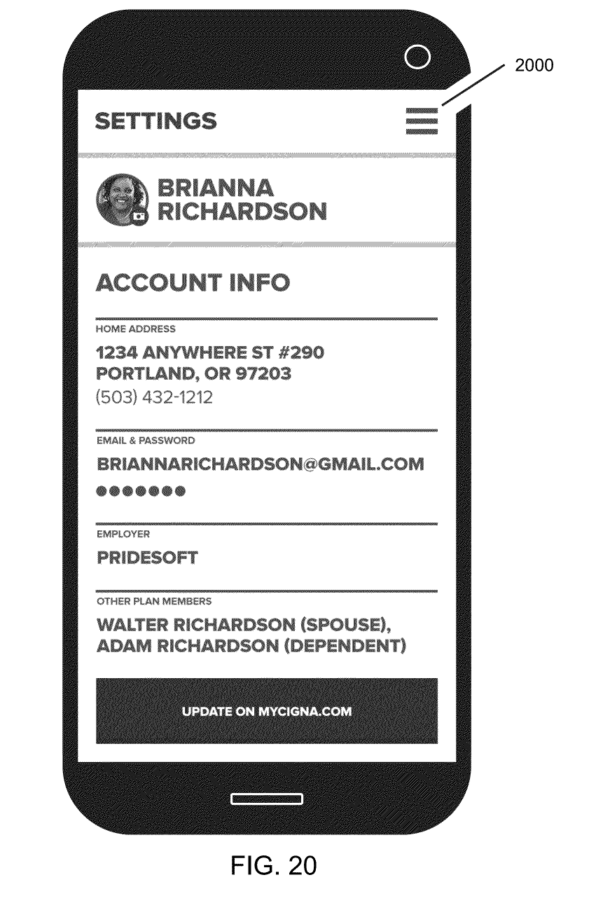

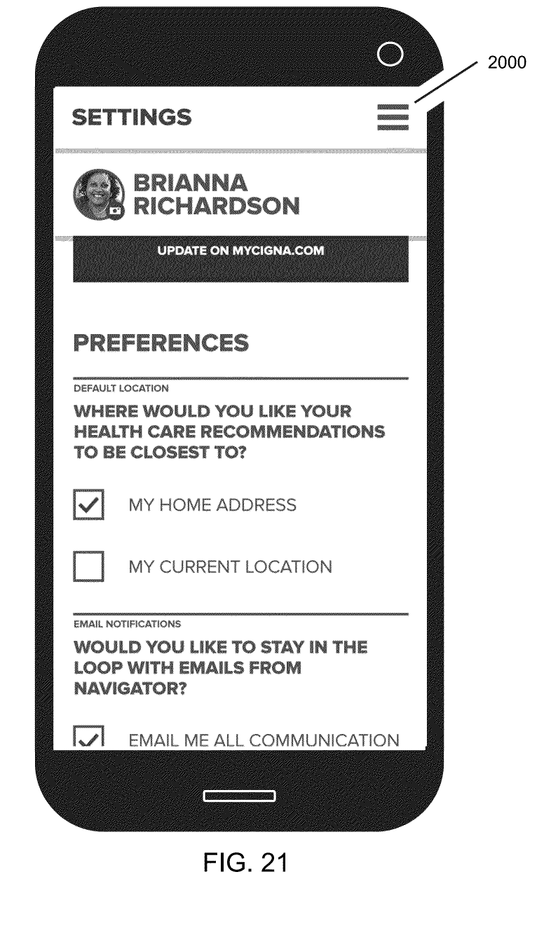

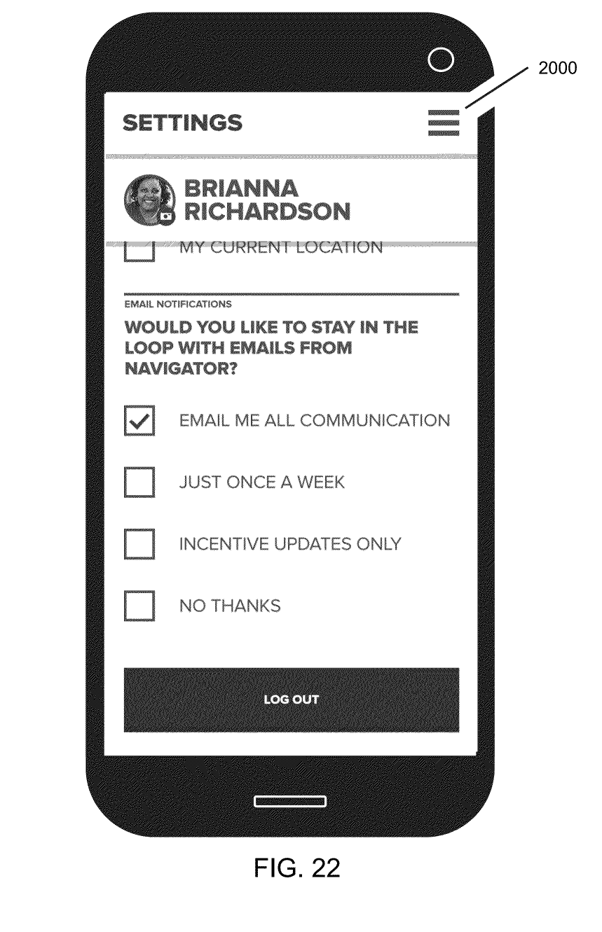

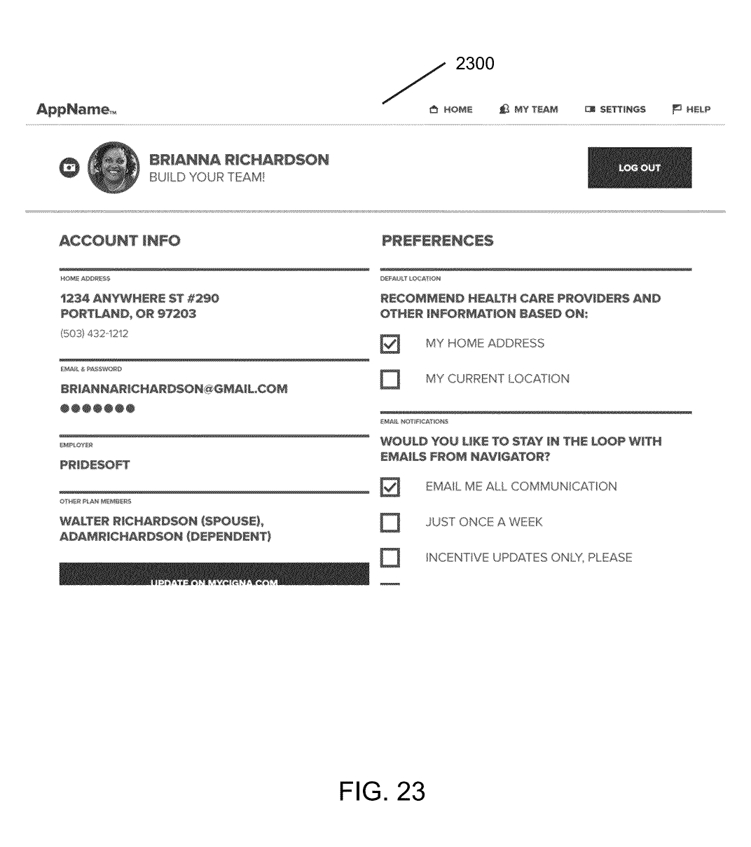

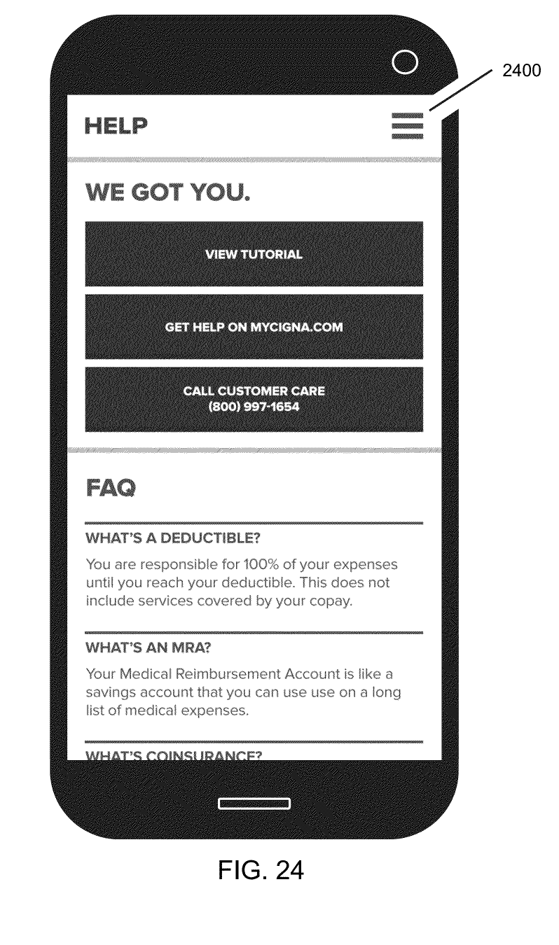

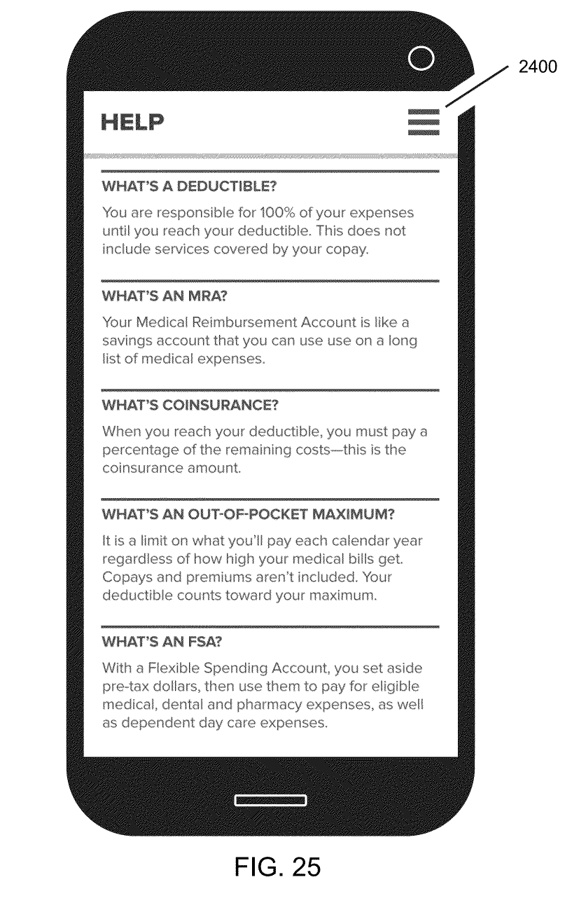

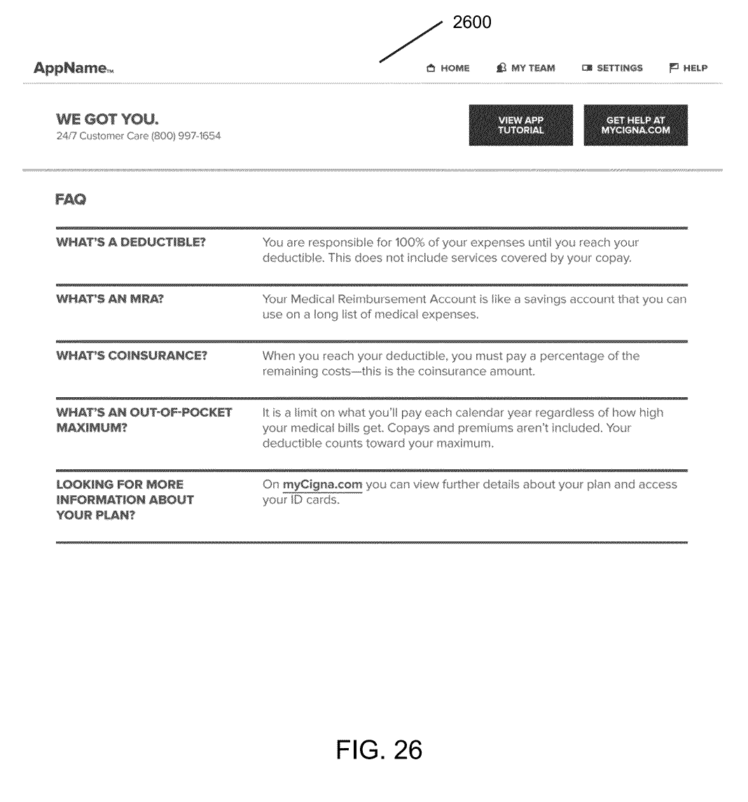

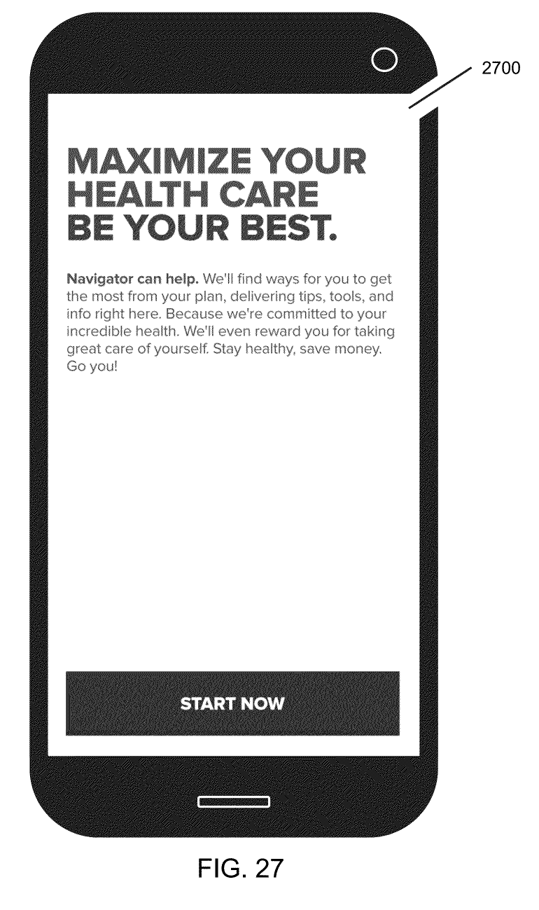

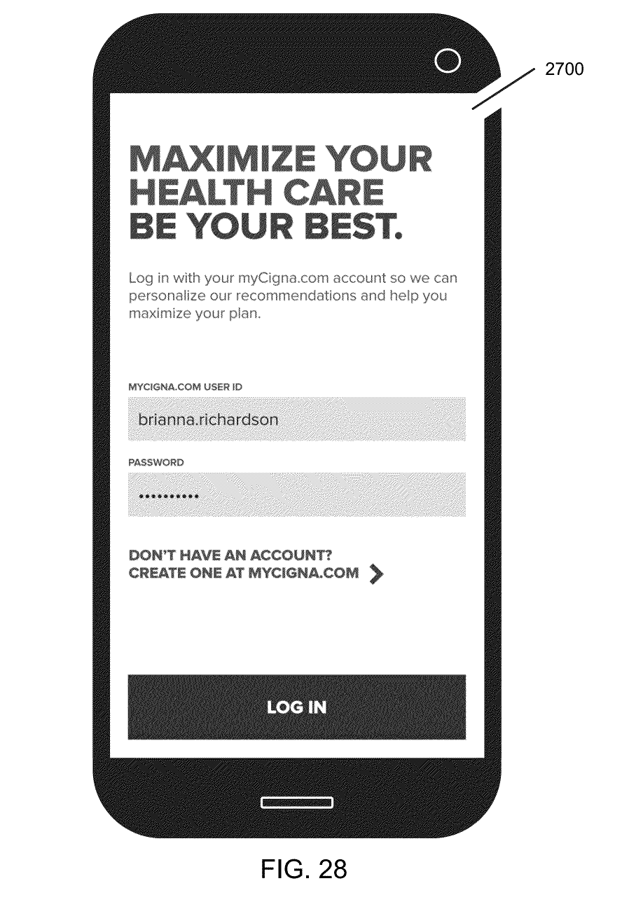

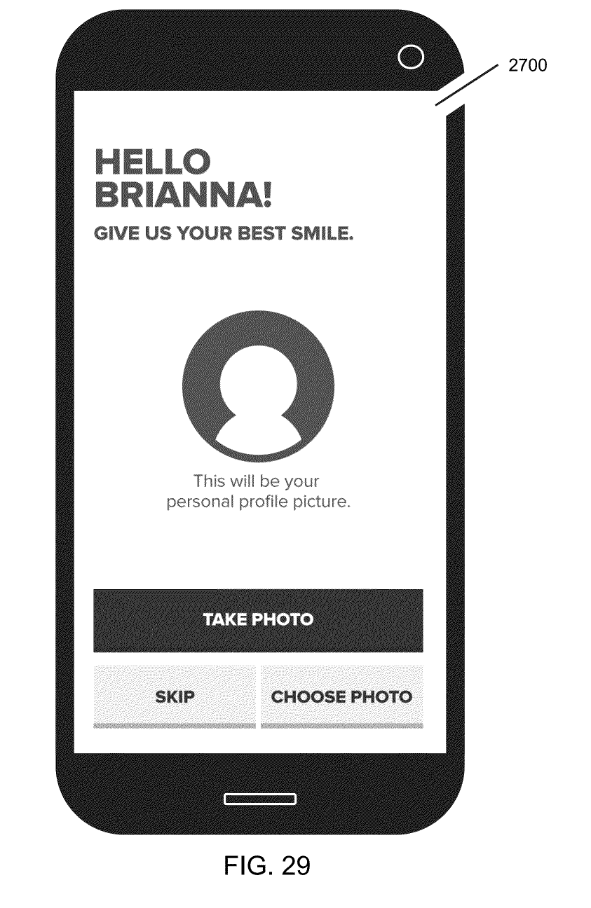

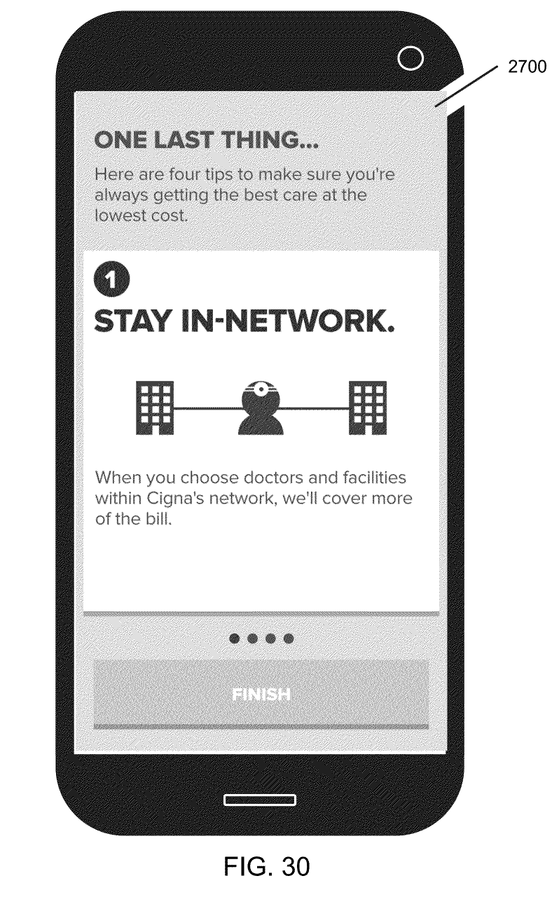

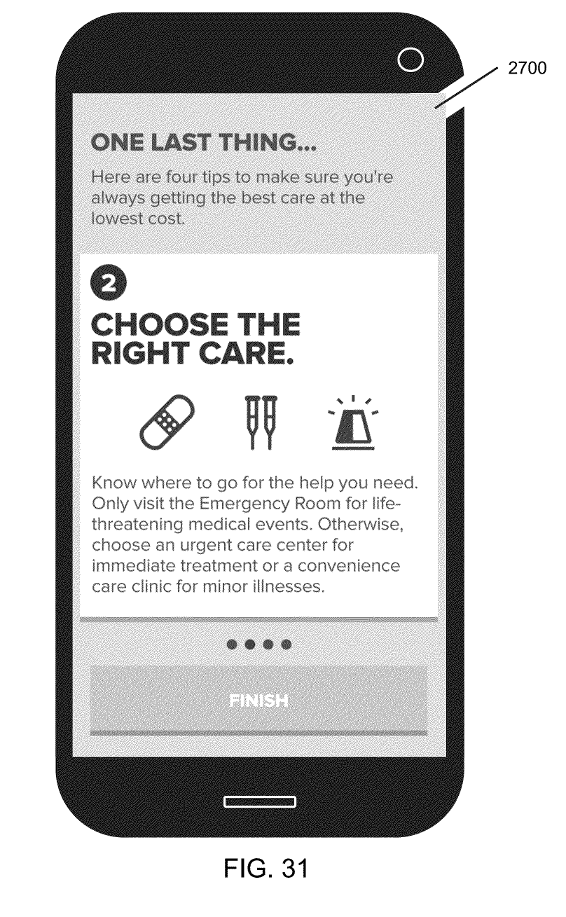

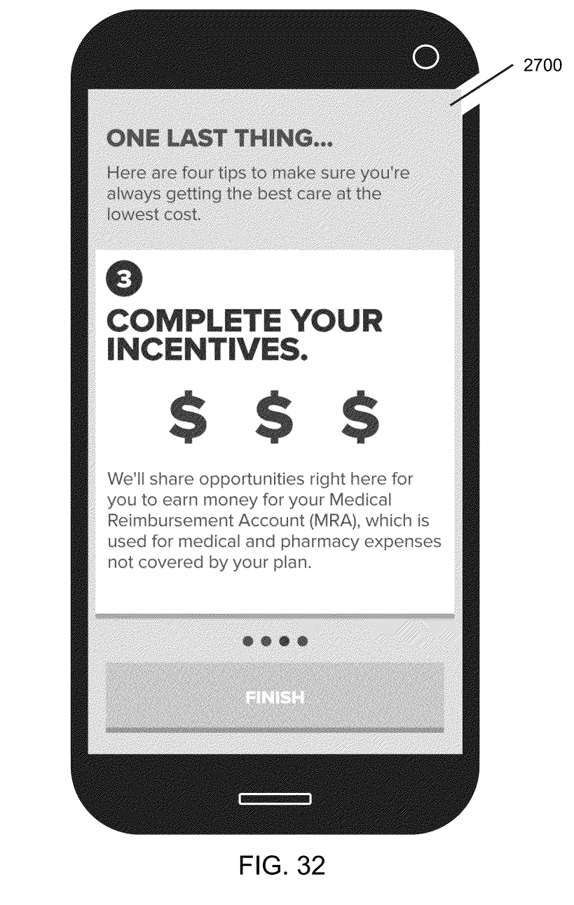

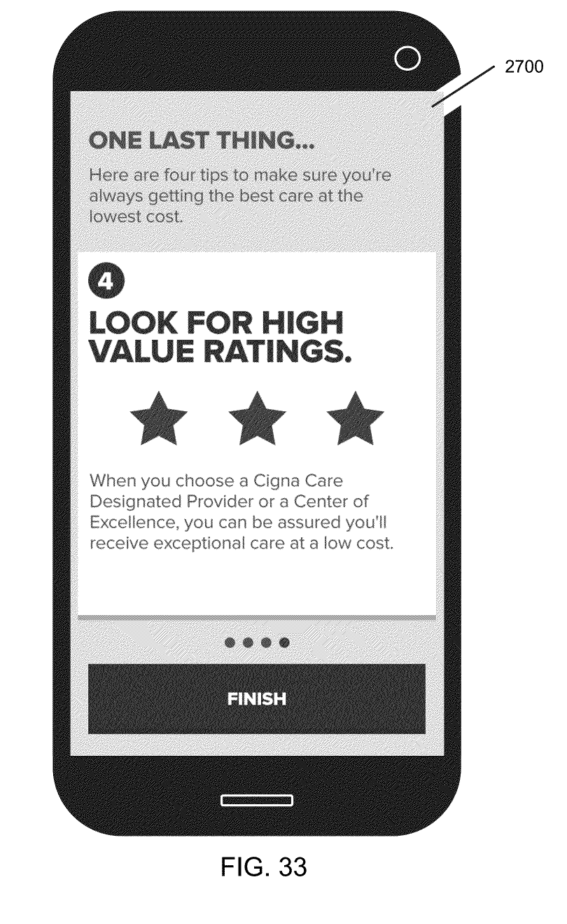

In one implementation, one or more user interfaces of the invention may provide features in addition or in lieu of foregoing features described herein. As an example, as illustrated in FIGS. 16-18, user interface 1300 enables a user to search for healthcare providers to add to the user's “health team.” As shown in FIGS. 20-22, user interface 2000 enables a user to add or modify account information, such as the user's contact information, password, employer information, healthcare plan information, preference information, etc. As depicted in FIGS. 24 and 25, user interface 2400 enables a user to access helplines, frequently asked questions, and other help channels. As illustrated in FIGS. 27-33, user interface 2700 enables a user to setup an account, and provides a tutorial for the user. It should be noted that one or more of the features described with respect to one of the user interfaces described herein may be provided, in some implementations, via one or more other user interfaces.

Exemplary Flowcharts

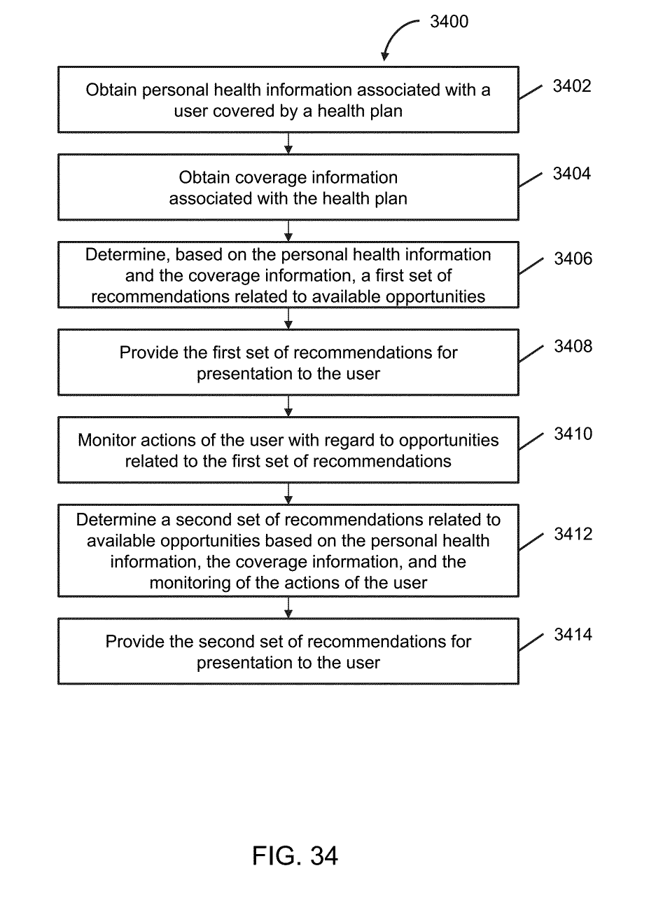

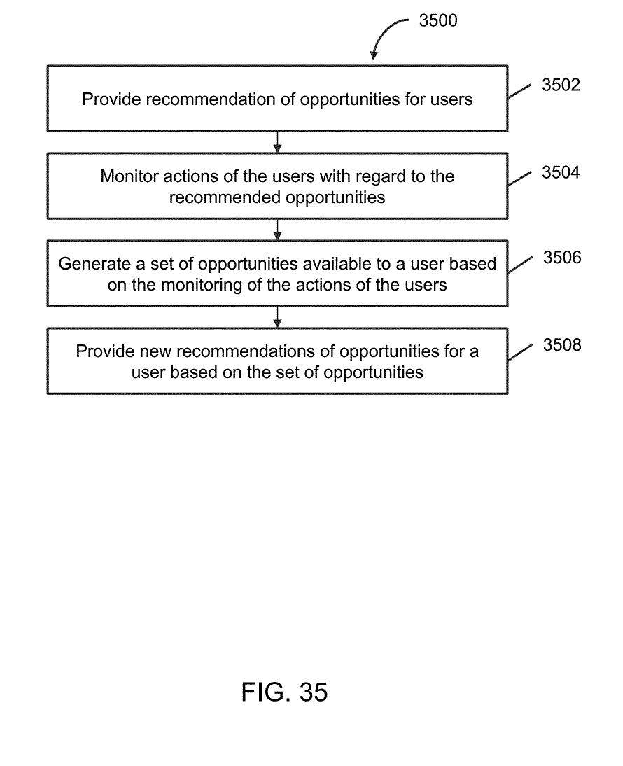

FIGS. 34 and 35 comprise exemplary illustrations of flowcharts of processing operations of methods that enable the various features and functionality of the system as described in detail above. The processing operations of each method presented below are intended to be illustrative and non-limiting. In some implementations, for example, the methods may be accomplished with one or more additional operations not described, and/or without one or more of the operations discussed. Additionally, the order in which the processing operations of the methods are illustrated (and described below) is not intended to be limiting.

In some implementations, the methods may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

FIG. 34 is an exemplary illustration of a flowchart of a method 3400 of providing recommendations of relevant opportunities to health plan customers, according to an aspect of the invention.

In an operation 3402, personal health information associated with a user (covered by a health plan) may be obtained. The personal health information may comprise demographic information, medical diagnoses information, surgical diagnoses information, family diagnoses information, medication information, lab results, or other personal health information. Operation 3402 may be performed by a data retrieval subsystem that is the same as or similar to data retrieval subsystem 106, in accordance with one or more implementations.

In an operation 3404, coverage information associated with the health plan (under which the user is covered) may be obtained. The coverage information may comprise benefits covered under the health plan, an expiration date of the health plan, deductibles associated with the health plan, co-payments associated with the health plan, healthcare providers covered under the health plan, or other coverage information. Operation 3404 may be performed by a data retrieval subsystem that is the same as or similar to data retrieval subsystem 106, in accordance with one or more implementations.

In an operation 3406, a first set of recommendations related to opportunities available to the user may be determined based on the personal health information and the coverage information. In some implementations, the first set of recommendations may be determined based on the personal health information, the coverage information, or other information (e.g., claim history associated with the user, service or product purchase history associated with the user, recommendation actions/inactions history associated with the user, etc.). Operation 3406 may be performed by a personalization subsystem that is the same as or similar to personalization subsystem 112, in accordance with one or more implementations.

In an operation 3408, one or more recommendations of the first set of recommendations may be provided for the user. As an example, the recommendations may be presented at a user interface of a health plan website or application for the user. As another example, the recommendations may be provided to the user via a social networking service, a messaging service, or other service. Operation 3408 may be performed by a personalization subsystem and/or a notification subsystem that are respectively the same as or similar to personalization subsystem 112 and/or notification subsystem 114, in accordance with one or more implementations.

In an operation 3410, one or more actions of the user (with regard to opportunities related to the first set of recommendations) may be monitored. As an example, the actions of the users may be monitored to determine whether and/or which recommended opportunities were acted on by the user, such as whether the user initiated steps toward obtaining a recommended opportunity after being presented with the recommended opportunity, whether the user completed some or all of the tasks necessary to obtain the recommended opportunity, etc. Operation 3410 may be performed by an activity subsystem that is the same as or similar to activity subsystem 108, in accordance with one or more implementations.

In an operation 3412, a second set of recommendations related to opportunities available to the user may be determined based on the personal health information, the coverage information, and the monitoring of the actions of the user. Operation 3412 may be performed by a personalization subsystem that is the same as or similar to personalization subsystem 112, in accordance with one or more implementations.

In an operation 3414, one or more recommendations of the second set of recommendations may be provided for the user. Operation 3414 may be performed by a personalization subsystem and/or a notification subsystem that are respectively the same as or similar to personalization subsystem 112 and/or notification subsystem 114, in accordance with one or more implementations.

FIG. 35 is an exemplary illustration of a flowchart of a method 3500 of generating relevant opportunities for health plan customers, according to an aspect of the invention.

In an operation 3502, one or more recommendations of opportunities may be provided for users. Operation 3502 may be performed by a personalization subsystem and/or a notification subsystem that are respectively the same as or similar to personalization subsystem 112 and/or notification subsystem 114, in accordance with one or more implementations.

In an operation 3504, actions of the users (with regard to the recommended opportunities) may be monitored. As an example, the actions of the users may be monitored to determine whether and/or which of the recommended opportunities were acted on by the users, such as whether a user initiated steps toward obtaining a recommended opportunity after being presented with the recommended opportunity, whether a user completed some or all of the tasks necessary to obtain the recommended opportunity, etc. Operation 3504 may be performed by an activity subsystem that is the same as or similar to activity subsystem 108, in accordance with one or more implementations.

In an operation 3506, a set of opportunities available to one or more users may be generated based on the monitoring of the action of the users. Operation 3506 may be performed by an opportunity subsystem that is the same as or similar to opportunity subsystem 110, in accordance with one or more implementations.

In an operation 3508, one or more new recommendations of opportunities may be provided for users based on the set of opportunities. Operation 3508 may be performed by a personalization subsystem that is the same as or similar to personalization subsystem 112, in accordance with one or more implementations.

Although the present invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

1. A method of providing personalized opportunities to health plan customers, the method being implemented on a computer system that includes one or more physical processors programmed with computer program instructions which, when executed, perform the method, the method comprising:
obtaining, by the computer system, personal health information associated with a user covered by a health plan;
obtaining, by the computer system, coverage information associated with the health plan, wherein the coverage information identifies one or more benefits that are at least partially covered by the health plan;
determining, by the computer system, based on the personal health information and the coverage information, a first set of recommendations related to opportunities available to the user;
providing, by the computer system, the first set of recommendations for presentation to the user;
monitoring, by the computer system, one or more inactions of the user with regard to one or more opportunities related to the first set of recommendations that are presented to the user, wherein the one or more inactions of the user comprises inaction of the user with respect to a first recommended opportunity viewed by the user;
determining, based on the monitoring of the one or more inactions, that the user has viewed, but did not act on, the first recommended opportunity;
determining, by the computer system, a second set of recommendations related to opportunities available to the user based on the personal health information, the coverage information, and the determination that the user has viewed, but did not act on, the first recommended opportunity; and
providing, by the computer system, the second set of recommendations for presentation to the user.

2. The method of claim 1, wherein the first set of recommendations are provided at a user interface, and wherein the second set of recommendations is determined based on whether and/or which of the one or more opportunities related to the first set of recommendations were accepted by the user via the user interface.

3. The method of claim 1, further comprising:
monitoring, by the computer system, actions of users with regard to opportunities recommended to the users; and
generating, by the computer system, a set of opportunities available to one or more users based on the monitoring of the actions of the users,
wherein the second set of recommendations is determined further based on the generated set of opportunities.

4. The method of claim 1, further comprising:
monitoring, by the computer system, one or more actions of the user with regard to the one or more opportunities related to the first set of recommendations;
determining, by the computer system, a set of opportunities available to the user that have not yet been recommended to the user or have not been recommended to the user for at least a predetermined threshold period of time;
determining, by the computer system, the one or more opportunities related to the first set of recommendations that have been taken by the user based on the monitoring of the one or more actions of the user; and
determining, by the computer system, one or more opportunities of the set of opportunities that are similar to at least one of the one or more taken opportunities,
wherein the second set of recommendations is determined further based on the one or more similar opportunities.

5. The method of claim 1, further comprising:
determining, by the computer system, a set of opportunities available to the user that have not yet been recommended to the user or have not been recommended to the user for at least a predetermined threshold period of time;
determining, by the computer system, other users that are similar to the user; and
determining, by the computer system, one or more opportunities of the set of opportunities that have been taken by at least one of the other similar users;
wherein the second set of recommendations is determined further based on the one or more taken opportunities.

6. The method of claim 1, wherein the user is part of a first set of users for which the first set of recommendations are provided, the method further comprising:
determining, by the computer system, one or more recommendations similar to at least one recommendation of the first set of recommendations;
determining, by the computer system, based on a makeup of the first set of users, a second set of users to be provided the one or more similar recommendations; and
providing, by the computer system, the one or more similar recommendations to the second set of users.

7. The method of claim 1, further comprising:
calculating, by the computer system, costs of services of a set of healthcare providers to the user based on the coverage information;
selecting, by the computer system, one or more healthcare providers of the set of healthcare providers based on the costs of the services to the user; and
providing, by the computer system, one or more recommendations of the one or more selected healthcare providers for performing a service associated with at least one recommendation of the first set of recommendations.

8. The method of claim 1, further comprising:
calculating, by the computer system, costs of services of a set of healthcare providers to a health plan provider associated with the health plan;
selecting, by the computer system, one or more healthcare providers of the set of healthcare providers based on the costs of the services to the health plan provider; and
providing, by the computer system, one or more recommendations of the one or more selected healthcare providers for performing a service associated with at least one recommendation of the first set of recommendations.

9. The method of claim 1, further comprising:
determining, by the computer system, a set of available times of one or more healthcare providers for performing a service associated with at least one recommendation of the first set of recommendations;
selecting, by the computer system, one or more available times of the set of available times based on preference information associated with the user, wherein the preference information indicates one or more preferred times of the user for healthcare services; and
providing, by the computer system, with the first set of recommendations, an indication for presentation to the user that the associated service is available to be scheduled at the one or more selected available times.

10. The method of claim 9, further comprising:
receiving, at the computer system, a user request from the user to schedule the associated service with a healthcare provider at one of the one or more selected available times; and
enabling, by the computer system, access of the healthcare provider to the personal health information of the user responsive to the receipt of the user request, and without user input specifying whether access of the health care provider to the personal health information is to be enabled.

11. A system for providing personalized opportunities to health plan customers, the system comprising:
one or more physical processors programmed with computer program instructions which, when executed, cause the one or more physical processors to:
obtain personal health information associated with a user covered by a health plan;
obtain coverage information associated with the health plan, wherein the coverage information identifies one or more benefits that are at least partially covered by the health plan;
determine, based on the personal health information and the coverage information, a first set of recommendations related to opportunities available to the user;
provide the first set of recommendations for presentation to the user;
monitor one or more inactions of the user with regard to one or more opportunities related to the first set of recommendations that are presented to the user, wherein the one or more inactions of the user comprises inaction of the user with respect to a first recommended opportunity viewed by the user;
determine, based on the monitoring of the one or more inactions, that the user has viewed, but did not act on, the first recommended opportunity;
determine a second set of recommendations related to opportunities available to the user based on the personal health information, the coverage information, and the determination that the user has viewed, but did not act on, the first recommended opportunity; and
provide the second set of recommendations for presentation to the user.

12. The system of claim 11, wherein the first set of recommendations are provided at a user interface, and wherein the second set of recommendations is determined based on whether and/or which of the one or more opportunities related to the first set of recommendations were accepted by the user via the user interface.

13. The system of claim 11, wherein the one or more physical processors are further caused to:
monitor actions of users with regard to opportunities recommended to the users; and
generate a set of opportunities available to one or more users based on the monitoring of the actions of the users,
wherein the second set of recommendations is determined further based on the generated set of opportunities.

14. The system of claim 11, wherein the one or more physical processors are further caused to:
monitor one or more actions of the user with regard to the one or more opportunities related to the first set of recommendations;
determine a set of opportunities available to the user that have not yet been recommended to the user or have not been recommended to the user for at least a predetermined threshold period of time;
determine the one or more opportunities related to the first set of recommendations that have been taken by the user based on the monitoring of the one or more actions of the user; and
determine one or more opportunities of the set of opportunities that are similar to at least one of the one or more taken opportunities,
wherein the second set of recommendations is determined further based on the one or more similar opportunities.

15. The system of claim 11, wherein the one or more physical processors are further caused to:
determine a set of opportunities available to the user that have not yet been recommended to the user or have not been recommended to the user for at least a predetermined threshold period of time;
determine other users that are similar to the user; and
determine one or more opportunities of the set of opportunities that have been taken by at least one of the other similar users;
wherein the second set of recommendations is determined further based on the one or more taken opportunities.

16. The system of claim 11, wherein the user is part of a first set of users for which the first set of recommendations are provided, and wherein the one or more physical processors are further caused to:
determine one or more recommendations similar to at least one recommendation of the first set of recommendations;
determine, based on a makeup of the first set of users, a second set of users to be provided the one or more similar recommendations; and
provide the one or more similar recommendations to the second set of users.

17. The system of claim 11, wherein the one or more physical processors are further caused to:
calculate costs of services of a set of healthcare providers to the user based on the coverage information;
select one or more healthcare providers of the set of healthcare providers based on the costs of the services to the user; and
provide one or more recommendations of the one or more selected healthcare providers for performing a service associated with at least one recommendation of the first set of recommendations.

18. The system of claim 11, wherein the one or more physical processors are further caused to:
calculate costs of services of a set of healthcare providers to a health plan provider associated with the health plan;
select one or more healthcare providers of the set of healthcare providers based on the costs of the services to the health plan provider; and
provide one or more recommendations of the one or more selected healthcare providers for performing a service associated with at least one recommendation of the first set of recommendations.

19. The system of claim 11, wherein the one or more physical processors are further caused to:
determine a set of available times of one or more healthcare providers for performing a service associated with at least one recommendation of the first set of recommendations;
select one or more available times of the set of available times based on preference information associated with the user, wherein the preference information indicates one or more preferred times of the user for healthcare services; and
provide, with the first set of recommendations, an indication for presentation to the user that the associated service is available to be scheduled at the one or more selected available times.

20. The system of claim 19, wherein the one or more physical processors are further caused to:
receive a user request from the user to schedule the associated service with a healthcare provider at one of the one or more selected available times; and
enable access of the healthcare provider to the personal health information of the user responsive to the receipt of the user request, and without user input specifying whether access of the health care provider to the personal health information is to be enabled.

21. (canceled)
